(19) United States
(12) Patent Application Publication
(10) Pub. No.: US 2025/0314104 A1
(43) Pub. Date: Oct. 9, 2025

(54) LOCKSET

(71) Applicant: SINOX CO., LTD., New Taipei City (TW)

(72) Inventors: Chia-Ming WU, New Taipei City (TW); Kuo-Kuang PAN, New Taipei City (TW); Jia-Qi WU, New Taipei City (TW)

(73) Assignee: SINOX CO., LTD., New Taipei City (TW)

(21) Appl. No.: 19/171,615

(22) Filed: Apr. 7, 2025

Related U.S. Application Data
(60) Provisional application No. 63/575,976, filed on Apr. 8, 2024.

(51) Int. Cl. E05B 73/00; E05B 37/02

(52) U.S. Cl. CPC E05B 73/0082; E05B 37/02

(57) ABSTRACT

A lockset is provided, including a housing, a hook, a driving device, and a lock body. The housing extends along an X-axis, and includes a front end and a rear end opposite to each other. The hook is arranged in the housing, and is rotatable relative to the housing. The hook includes a front end portion that partially extends out of the front end. A portion of the driving device is arranged in the housing, and a portion thereof extends out of the housing from the rear end or between the rear end and the front end. The driving device is ratable relative to the X-axis to change an extent to which the front end portions are opened relative to the X-axis. The lock body is arranged on a side of the driving device. When the lock body is closed, the lock body limits the rotation of the driving device.

### TECHNICAL FIELD

The utility model relates to a lockset. Further, the utility model relates to a lockset for an electronic device.

### BACKGROUND

In modern life, consumer electronic products play an important role. With fast-paced lifestyle and people's demand for instant information, portable electronic products become one of people's necessities. However, the products are more easily stolen or robbed due to relatively high unit prices and ease of realization.

To prevent others from stealing, a lockset is designed, for example, a notebook computer lock. A latch of the notebook computer lock can be connected to an anti-theft lock hole of an electronic product, and movement of the latch is controlled through a mechanism of a key lock to complete the purpose of opening/closing the lock. However, the anti-theft lock hole has different specifications, so that a user needs to purchase/carry a lockset with a corresponding latch based on the specification of the anti-theft lock hole, which is not only uneconomical but also inconvenient to use. In addition, user-friendliness of operation of the lockset also has room for improvement.

### SUMMARY

One object of the utility model is to provide a lockset. The lockset is applicable to lock holes of different sizes and is convenient to use.

Another object of the utility model is to provide a lockset, which is more user-friendly in operation.

The lockset of the utility model includes a housing, a hook, a driving device, and a lock body. The housing extends along an X-axis, and includes a front end and a rear end opposite to each other. The hook is arranged in the housing, and is rotatable relative to the housing. The hook includes a front end portion that partially extends out of the front end. A portion of the driving device is arranged in the housing, and a portion thereof extends out of the housing from the rear end or between the rear end and the front end. The driving device is ratable relative to the X-axis to change an extent to which the front end portions are opened relative to the X-axis. The lock body is arranged on a side of the driving device. When the lock body is closed, the lock body limits the rotation of the driving device.

In an embodiment of the utility model, the hook includes a rear end portion extending in a direction opposite to the front end portion. The driving device includes a force application member and a driving member. The force application member includes a force bearing portion extending out of the housing from the rear end and a force application portion arranged inside the housing, where the force bearing portion and the force application portion are connected and rotatable associatively relative to the housing. The driving member is arranged in the housing and rotatable associatively with the force application member, where the driving member has a driving member inner wall, a distance between the driving member inner wall and the X-axis varies along a circumferential direction, and the rear end portion is arranged in the driving member and abuts against the driving member inner wall. The lock body includes an engagement member movable along the X-axis direction. When the lock body is closed, an end of the engagement member is engaged with a driving member surface of the driving member to limit the rotation of the driving device.

In an embodiment of the utility model, the hook includes a rear end portion extending in a direction opposite to the front end portion. The driving device includes a force application member and a driving member. The force application member includes a force bearing portion extending out of the housing from the rear end and a force application portion arranged inside the housing, where the force bearing portion and the force application portion are connected and rotatable associatively relative to the housing. The driving member is arranged in the housing and rotatable associatively with the force application member to move along an X-axis direction on a side of the rear end portion facing the X-axis, and abuts against the rear end portion to change an extent to which the front end portions are opened. The lock body includes an engagement member, the engagement member is movable along a direction perpendicular to the X-axis, and extends through the force application member and the driving member to reach a housing inner wall of the housing, and when the lock body is closed, an end of the engagement member is engaged with the housing inner wall to limit the rotation of the driving device.

In an embodiment of the utility model, the driving device further includes a displacement limiting member fixed in the housing, the displacement limiting member has therein an accommodating space extending along the X-axis, and a side wall of the accommodating space is provided with a side wall thread. The driving member is arranged in the accommodating space, and the driving member is a cylinder having a driving member thread on a side surface that matches the side wall thread. When the force application member is rotated, the driving member is rotated associatively, and under an action between the side wall thread and the driving member thread, an end of the driving member facing the rear end portion is moved along the X-axis direction.

In an embodiment of the utility model, the hook includes a rear end portion extending in a direction opposite to the front end portion. The driving device includes a force application member and a driving member. The force application member is arranged around the housing between the rear end and the front end, where the force application member has a force application member inner wall, and the force application member inner wall has a force application member engagement portion. The driving member is arranged in the housing, where the driving member has a driving member surface and a driving member inner wall, the driving member surface has a driving member fixture block, the driving member fixture block extends through the housing to enter force application member engagement portion, to cause the driving member and the force application member to rotate associatively, a distance between the driving member inner wall and the X-axis varies along a circumferential direction, and the rear end portion is arranged in the driving member and abuts against the driving member inner wall. The lock body includes an engagement member movable along a direction of the X-axis. When the lock body is closed, an end of the engagement member abuts against an end of the driving member away from the hook to limit the movement of the driving member along the X-axis.

In an embodiment of the utility model, the housing has a hollowed-out portion, and the hollowed-out portion includes a movement groove extending relative to the X-axis along a circumferential direction and a plurality of limiting grooves extending from the movement groove to the hook along the X-axis direction. When the lock body is opened, the driving member fixture block is movable in the movement groove and the plurality of limiting grooves, and when the lock body is closed, the driving member fixture block is located in one of the plurality of limiting grooves.

In an embodiment of the utility model, the hook includes a rear end portion extending in a direction opposite to the front end portion. The driving device includes a force application member and a driving member. The force application member includes a force bearing portion extending out of the housing from the rear end and a force application portion arranged inside the housing, where the force bearing portion and the force application portion are connected and rotatable associatively relative to the housing, and the force application member has a segment gap surface on a side facing the hook. The driving member is arranged in the housing and has a driving member inner wall, where a distance between the driving member inner wall and the X-axis gradually increases as approaching the hook, the driving member inner wall abuts against the rear end portion, an other side of the driving member relative to the hook abuts against the segment gap surface, and the force application member is rotated to cause the driving member to move along the X-axis direction to change an extent to which the front end portions are opened. The lock body includes an engagement member movable along the X-axis direction. When the lock body is closed, an end of the engagement member is engaged with a force application member surface of the force application member to limit the rotation of the driving device.

In an embodiment of the utility model, the hook includes a rear end portion extending in a direction opposite to the front end portion. The driving device includes a force application member, a transmission member, and a driving member. The force application member includes a force bearing portion extending out of the housing from the rear end and a force application portion arranged inside the housing, where the force bearing portion and the force application portion are connected and rotatable associatively relative to the housing. The transmission member is arranged in the housing, rotatable associatively with the force application member, and movable along an X-axis direction. The driving member is arranged in the housing and having a driving member inner wall, where a distance between the driving member inner wall and the X-axis gradually increases as approaching the hook, the driving member inner wall abuts against the rear end portion, an other side of the driving member relative to the hook abuts against abuts against the transmission member, and the force application member is rotated to cause the transmission member to move along the X-axis direction, and drives the driving member to move along the X-axis direction to change an extent to which the front end portions are opened. The lock body includes an engagement member movable along the X-axis direction. When the lock body is closed, an end of the engagement member is engaged with a force application member surface of the force application member to limit the rotation of the driving device.

In an embodiment of the utility model, the driving device further includes a displacement limiting member fixed in the housing, the displacement limiting member has therein an accommodating space extending along the X-axis, and a side wall of the accommodating space is provided with a side wall thread. The transmission member is arranged in the accommodating space, and the transmission member is a circular cylinder having a transmission member thread on a side surface that matches the side wall thread. When the force application member is rotated, the transmission member is rotated associatively, and under an action between the side wall thread and the transmission member thread, the transmission member moves along the X-axis direction.

In an embodiment of the utility model, the lock body is a key lock, and the engagement member includes a protruding post.

In an embodiment of the utility model, the lock body is a combination lock, and the engagement member includes a lock shaft rod.

### BRIEF DESCRIPTION OF THE DRAWINGS

FIG. 1A to FIG. 1C are schematic diagrams of an embodiment of a lockset according to the utility model.

FIG. 1D and FIG. 1E are schematic exploded views of an embodiment of a lockset according to the utility model.

FIG. 1F to FIG. 1N are schematic diagrams showing operation of an embodiment of a lockset according to the utility model.

FIG. 2A and FIG. 2B are schematic diagrams of different embodiments of a lockset according to the utility model.

FIG. 2C is a schematic diagram of different embodiments of a lockset according to the utility model.

FIG. 2C1 is a close-up view of a cross section of an inner circumference surface of a force application portion and an outer peripheral surface of a driving member of a lockset according to the utility model.

FIG. 2D is another schematic diagram of different embodiments of a lockset according to the utility model.

FIG. 2E is a schematic diagram of a combination of different embodiments of a lockset according to the utility model.

FIG. 2F to FIG. 2I are schematic diagrams showing operation of different embodiments of a lockset according to the utility model.

FIG. 3A and FIG. 3B are schematic diagrams of different embodiments of a lockset according to the utility model.

FIG. 3C is a schematic diagram of different embodiments of a lockset according to the utility model.

FIG. 3D to FIG. 3I are schematic diagrams showing operation of different embodiments of a lockset according to the utility model.

FIG. 4A and FIG. 4B are schematic diagrams of different embodiments of a lockset according to the utility model.

FIG. 4C is a schematic diagram of a combination of different embodiments of a lockset according to the utility model.

FIG. 4D is a schematic diagram of different embodiments of a lockset according to the utility model.

FIG. 4E to FIG. 4H are schematic diagrams showing operation of different embodiments of a lockset according to the utility model.

FIG. 4I is an exploded schematic diagram of different embodiments of a driving member and a driving member inner wall of a lockset according to the utility model.

FIG. 5A is a schematic diagram of different embodiments of a lockset according to the utility model.

FIG. 5B is a schematic diagram of a combination of different embodiments of a lockset according to the utility model.

FIG. 5C to FIG. 5F are schematic diagrams showing operation of different embodiments of a lockset according to the utility model.

FIG. 6A is a schematic diagram of different embodiments of a lockset according to the utility model.

FIG. 6B is a schematic diagram of a combination of different embodiments of a lockset according to the utility model.

FIG. 6C to FIG. 6F are schematic diagrams showing operation of different embodiments of a lockset according to the utility model.

FIG. 7A is a schematic diagram of different embodiments of a lockset according to the utility model.

FIG. 7B is a schematic diagram of a combination of different embodiments of a lockset according to the utility model.

FIG. 7C to FIG. 7E are schematic diagrams showing operation of different embodiments of a lockset according to the utility model.

### DETAILED DESCRIPTION

A lockset of the utility model is applicable to an electronic device, and is connected to a lock hole on the electronic device. The electronic device is preferably a portable electronic device, such as, but is not limited to, a notebook computer, a tablet computer, a mobile phone, an e-book, a digital frame, a global positioning system navigator, a mobile network device, a personal digital assistant, a digital walkman, or an electronic dictionary.

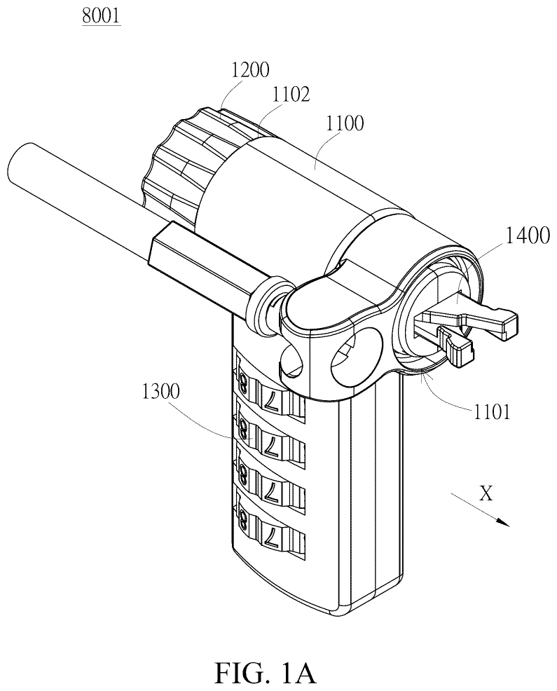

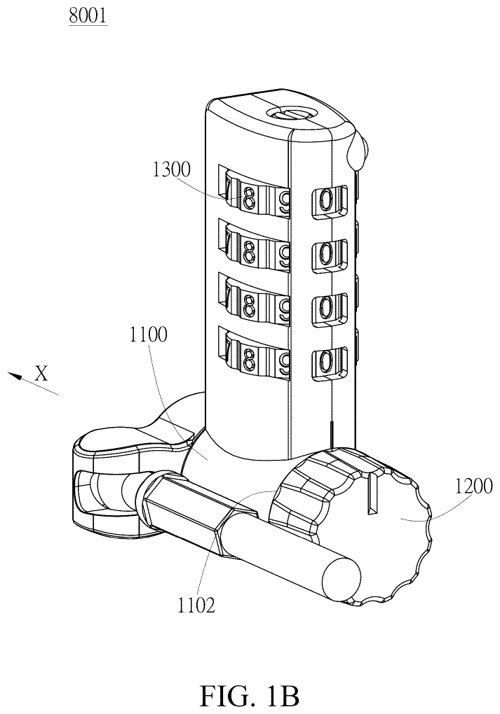

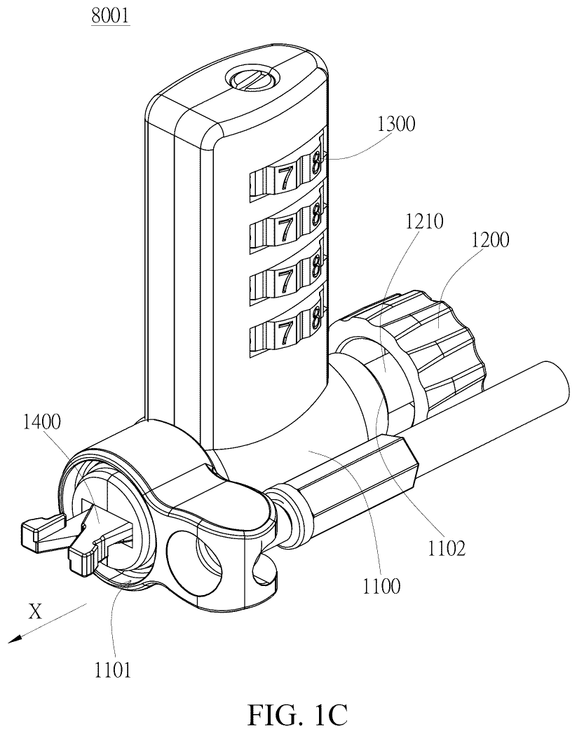

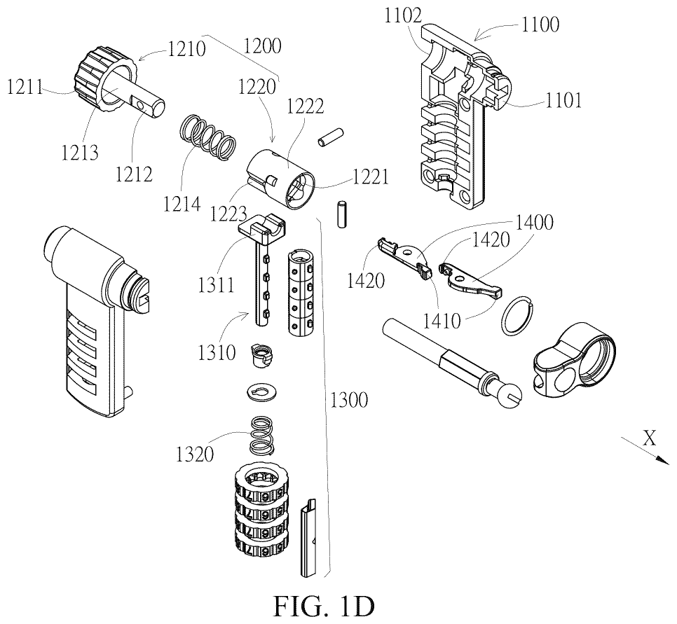

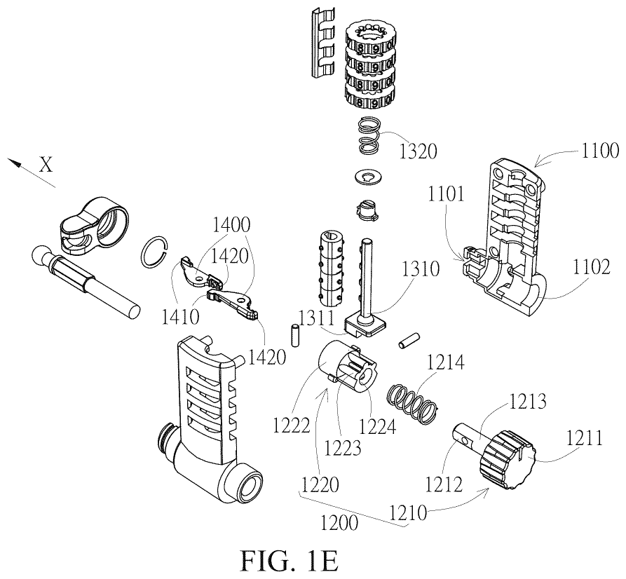

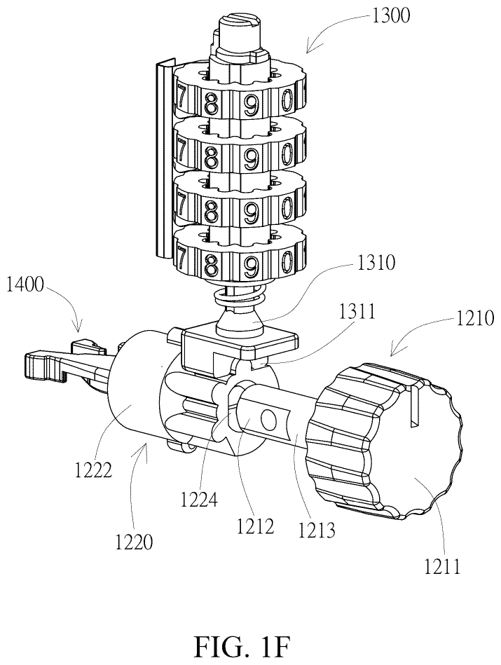

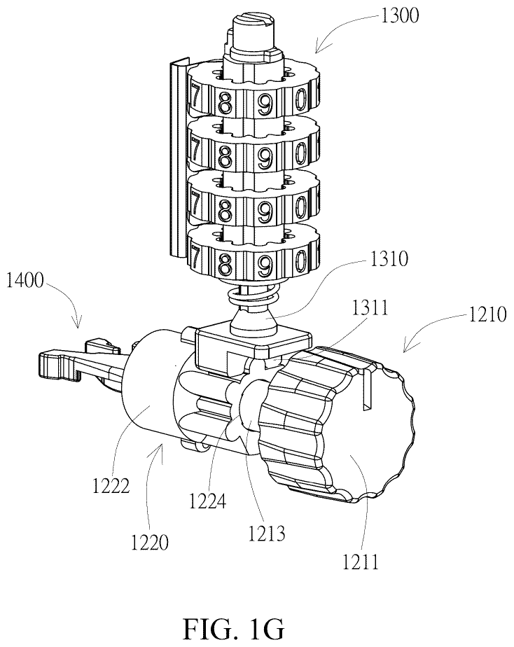

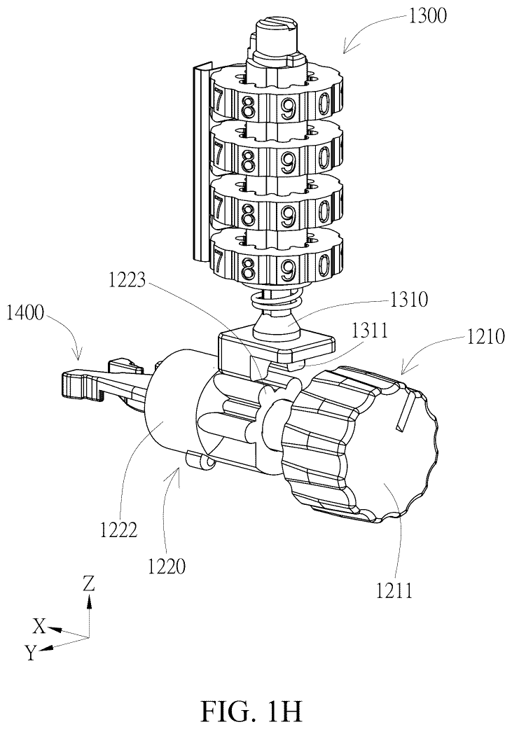

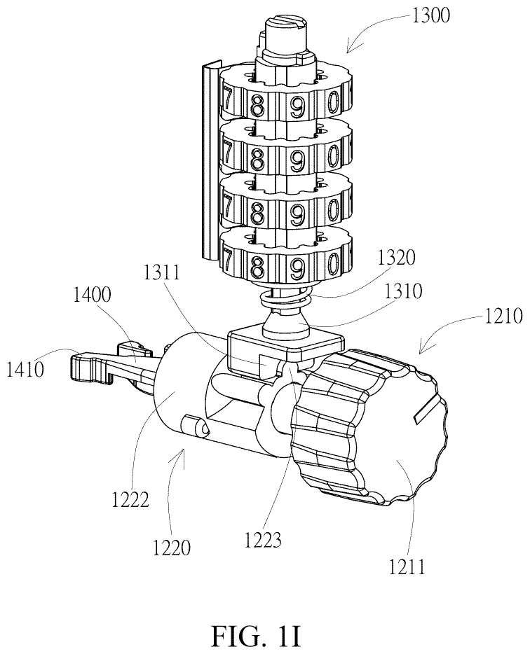

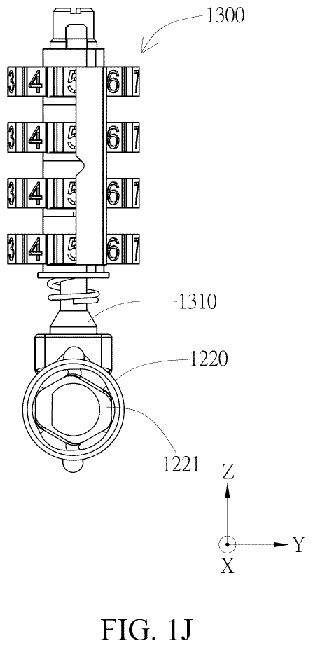

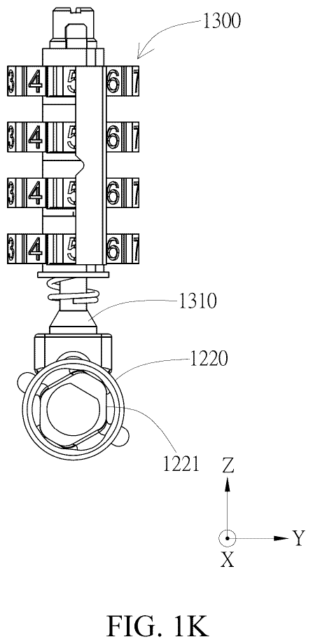

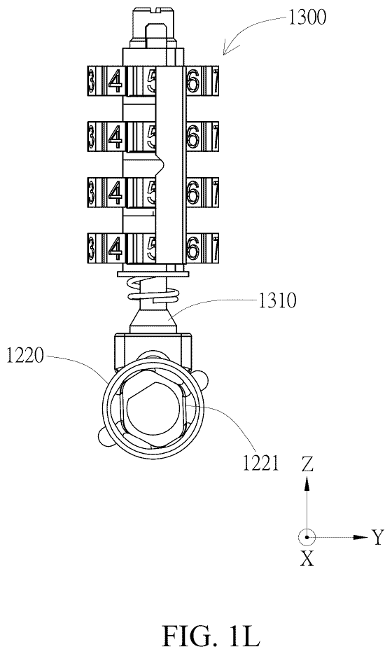

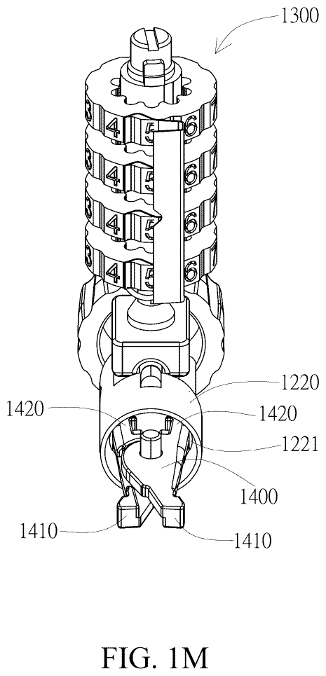

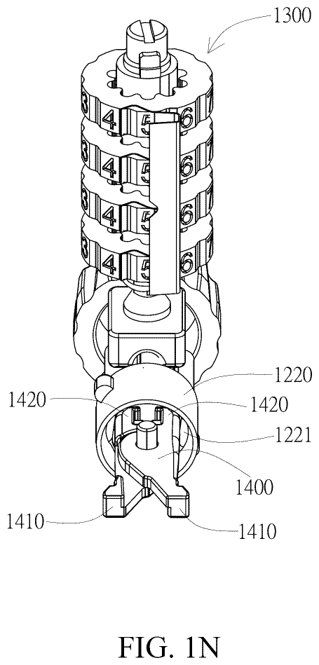

In embodiments shown in FIG. 1A to FIG. 1E, a lockset 8001 of the utility model includes a housing 1100, a hook 1400, a driving device 1200, and a lock body 1300. The housing 1100 extends along an X-axis, and includes a front end 1101 and a rear end 1102 opposite to each other. The hook 1400 is arranged in the housing 1100, and can be rotated relative to the housing 1100. The hook 1400 is preferably arranged in pairs, each including a front end portion 1410 partially extending out of the front end 1101. A portion of the driving device 1200 is arranged in the housing 1100, and a portion thereof extends out of the housing 1100 from the rear end 1102. The driving device 1200 can be rotated relative to the X-axis to change an extent to which the front end portions 1410 are opened relative to the X-axis. The lock body 1300 is arranged on a side of the driving device 1200. When the lock body 1300 is closed, the lock body 1300 limits the rotation of the driving device 1200.

Further, in the embodiments shown in FIG. 1D and FIG. 1E, the hook 1400 includes a rear end portion 1420 extending in a direction opposite to the front end portion 1410. The driving device 1200 includes a force application member 1210 and a driving member 1220. The force application member 1210 includes a force bearing portion 1211 extending out of the housing 1100 from the rear end 1102 and a force application portion 1212 arranged inside the housing 1100. The force bearing portion 1211 and the force application portion 1212 are connected through, for example, a rod member 1213, and can be rotated associatively relative to the housing 1100. The driving member 1220 is arranged in the housing 1100, and rotates associatively with the force application member 1210. The driving member 1220 is preferably in a shape of a cylinder and has a driving member inner wall 1221. A distance between the driving member inner wall 1221 and the X-axis varies along a circumferential direction. The rear end portion 1420 is arranged in the driving member 1220 and abuts against the driving member inner wall 1221. The lock body 1300 includes an engagement member 1310 that can be moved along a direction perpendicular to the X-axis. When the lock body 1300 is closed, an end 1311 of the engagement member 1310 is engaged with a driving member surface 1222 of the driving member 1220 to limit the rotation of the driving device 1220. In this embodiment, the lock body 1300 is a combination lock, and the engagement member 1310 includes a lock shaft rod.

More specifically, the force application member 1210 can overcome an elastic force generated by compression of an elastic device 1214 such as a spring, so that the force application portion 1212 is inserted into the driving member 1220 and engaged with the limiting portion 1224. As a result, the driving member 1220 can be rotated associatively with the force application member 1210. The engagement member 1310 may cause one end 1311 to abut against the driving member surface 1222 through an elastic force of an elastic device 1320 such as a spring. When the lock body 1300 is closed (that is, the lockset 8001 is in a locked state), a displacement of the engagement member 1310 is limited. Because the end 1311 is engaged with the driving member surface 1222, the rotation of the driving member 1220 is limited. When the lock body 1300 is opened (that is, the lockset 8001 is in an unlocked state), the engagement member 1310 may be moved, and the driving member 1220 is not limited. The force application member 1210 inserted into the driving member 1220 can be rotated to drive the driving member 1220 to rotate, so that the rear end portion 1420 that abuts against the driving member inner wall 1221 moves. As a result, the hook 1400 is rotated to change an extent to which the front end portions 1410 are opened relative to the X-axis.

Actions of internal elements of the lockset 8001 are described below by using embodiments shown in FIG. 1F to FIG. 1N. For clarity, elements such as a housing 1100 are not illustrated in FIG. 1F to FIG. 1N.

In the embodiment shown in FIG. 1F, the force application portion 1212 is not inserted into the limiting portion 1224 of the driving member 1220. Next, in the embodiment shown in FIG. 1G, the force application member 1210 can move in the X-axis direction as a result of an external force exerted by a user on the force bearing portion 1211, so that the force application portion 1212 is inserted into the limiting portion 1224 of the driving member 1220. For example, the force application portion 1212 can be engaged with the limiting portion 1224 after being inserted into the driving member 1220 by means of a design in which sections that are adaptable with each other are respectively arranged on the force application portion 1212 and the limiting portion 1224.

Then, in the embodiment shown in FIG. 1H, when the lock body 1300 is opened (for example, a character wheel of the lock body 1300 is rotated to an unlocked position), the engagement member 1310 may move along a Z-axis, so that the end 1311 can leave a driving member engagement portion 1223 located on the driving member surface 1222. In other words, the driving member engagement portion 1223 can be disengaged from the engagement of the end 1311. The driving member engagement portion 1223 may be a bump arranged around the driving member surface 1222, and the end 1311 may have a groove portion that can engaged with the bump. In this way, the rotation of the driving member 1220 is not limited. When the force application member 1210 is rotated in a direction parallel to a YZ plane as a result of an external force exerted by the user on the force bearing portion 1211, the force application member 1210 inserted into the driving member 1220 can be rotated to drive the driving member 1220 to rotate, so that the rear end portion 1420 that abuts against the driving member inner wall 1221 moves. As a result, the hook 1400 is rotated to change an extent to which the front end portions 1410 are opened relative to the X-axis. The X-axis, the Y-axis, and the Z-axis are orthogonal.

In the embodiment shown in FIG. 1I, when the force application member 1210 rotates and drives the driving member 1220 to rotate to a desired position, the driving member engagement portion 1223 is engaged with the end 1311. In this way, if the lock body 1300 is locked (for example, a character wheel of the lock body 1300 is rotated to a locked position), the movement of the engagement member 1310 along the Z-axis can be limited, thereby limiting the rotation of the driving member 1220. As a result, the front end portion 1410 has a desired opening extent, for example, slightly wider than a width of a lock hole of an electronic device, and is engaged with and fixed to the lock hole.

A relationship between the rotation of the driving member 1220 and the opening extent of the front end portion 1410 is further described. In embodiments shown in FIG. 1J to FIG. 1L, the driving member 1220 has a driving member inner wall 1221, and a distance between the driving member inner wall 1221 and the X-axis varies along a circumferential direction. According to another aspect, in embodiments shown in FIG. 1M to FIG. 1N, the rear end portion 1420 is arranged in the driving member 1220 and abuts against the driving member inner wall 1221. Therefore, the rear end portion 1420 that abuts against the driving member inner wall 1221 can be moved by the rotation of the driving member 1220. As a result, the hook 1400 is rotated to change an extent to which the front end portions 1410 are opened relative to the X-axis.

Based on the above, the lockset 8001 of the utility model is applicable to lock holes of different sizes and is convenient to use. However, the above operation can be achieved by rotating the force application member 1210 performed by the user, which is more user-friendly in operation. According to another aspect, in a different embodiment, the lockset of the utility model includes a housing, a hook, a driving device, a lock body, and the like, which can be arranged differently according to a requirement.

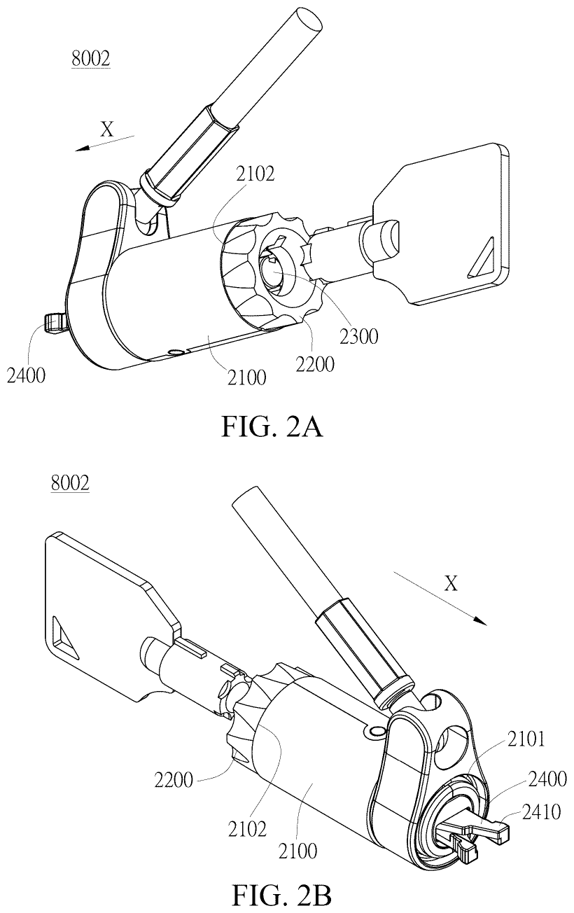

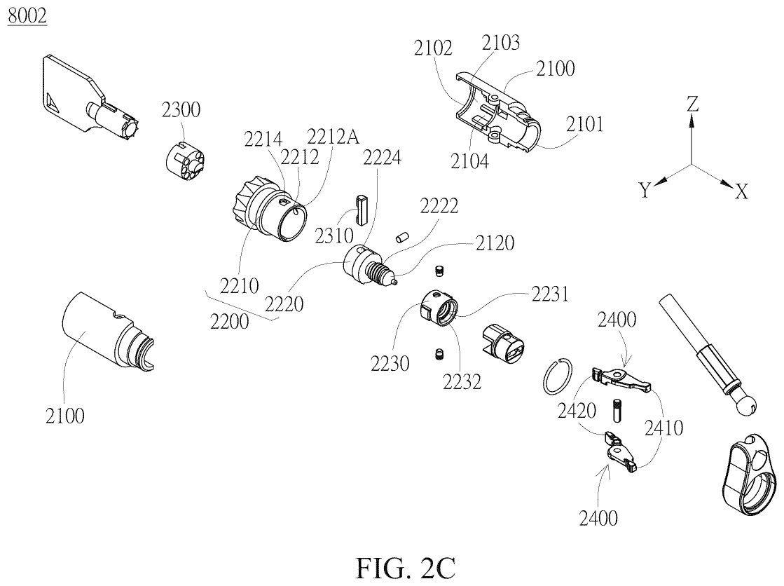

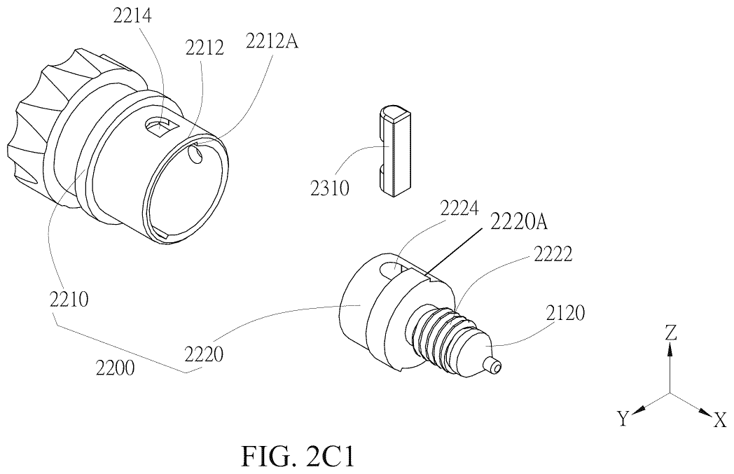

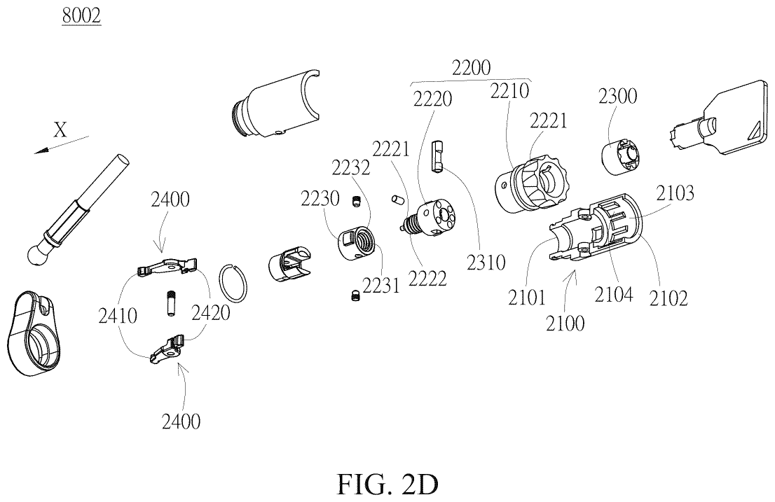

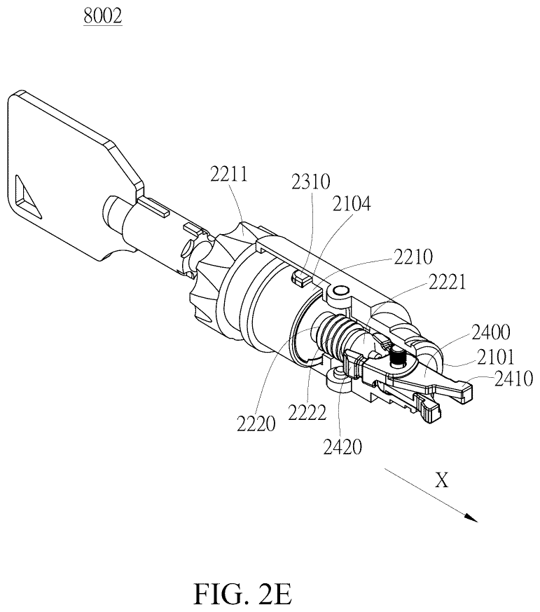

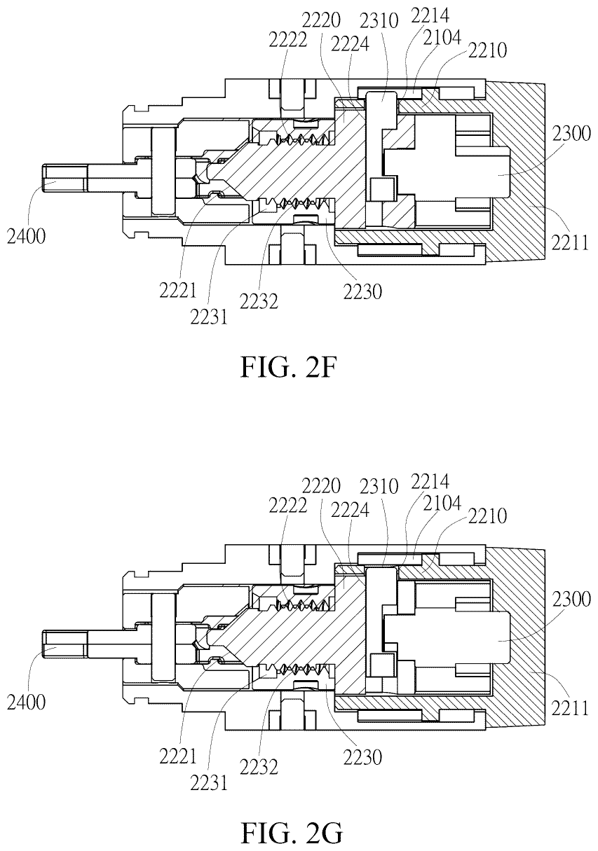

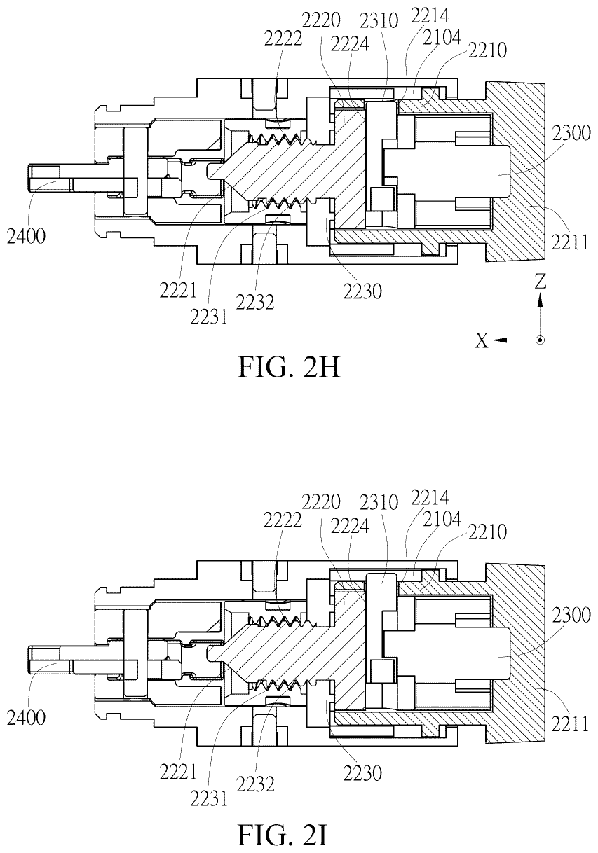

In embodiments shown in FIG. 2A to FIG. 2E, a lockset 8002 of the utility model includes a housing 2100, a hook 2400, a driving device 2200, and a lock body 2300. The housing 2100 extends along an X-axis, and includes a front end 2101 and a rear end 2102 opposite to each other. The hook 2400 is arranged in the housing 2100, and can be rotated relative to the housing 2100. The hook 2400 is preferably arranged in pairs, each including a front end portion 2410 partially extending out of the front end 2101. A portion of the driving device 2200 is arranged in the housing 2100, and a portion thereof extends out of the housing 2100 from the rear end 2102. The driving device 2200 can be rotated relative to the X-axis to change an extent to which the front end portions 2410 are opened relative to the X-axis. The lock body 2300 is arranged on a side of the driving device 2200. When the lock body 2300 is closed, the lock body 2300 limits the rotation of the driving device 2200.

Further, in the embodiments shown in FIG. 2C to FIG. 2E, the hook 2400 includes a rear end portion 2420 extending in a direction opposite to the front end portion 2410. The driving device 2200 includes a force application member 2210 and a driving member 2220. The force application member 2210 includes a force bearing portion 2211 extending out of the housing 2100 from the rear end 2102 and a force application portion 2212 arranged inside the housing 2100, where the force bearing portion 2211 and the force application portion 2212 are connected and can be rotated associatively relative to the housing 2100. The driving member 2220 is arranged in the housing 2100. For example, the driving member 2220 may be rotated associatively with the force application member 2210 by a design (see FIG. 2C1) in which sections 2212A and 2220A that are adaptable with each other are respectively arranged on an inner circumference surface of the force application portion 2212 and a peripheral surface of the driving member 2220, moves along the X-axis direction on a side of the rear end portion 2420 facing the X-axis, and abuts against the rear end portion 2420 to change an extent to which the front end portions 2410 are opened. The lock body 2300 includes an engagement member 2310, the engagement member 2310 can be moved along a direction perpendicular to the X-axis, and extends through a hole 2214 of the force application member 2210 and a hole 2224 of the driving member 2220 to reach a housing inner wall 2103 of the housing 2100, and when the lock body 2300 is closed, an end of the engagement member 2310 is engaged with the housing inner wall 2103 to limit the rotation of the driving device 2200. The inner wall 2103 of the housing may be further provided with a groove portion 2104, which is configured to engaged with the engagement member 2310 more stably. In this embodiment, the lock body 2300 is a key lock, and the engagement member 2310 includes a protruding post.

More specifically, in the embodiments shown in FIG. 2F to FIG. 2I, the driving device 2200 further includes a displacement limiting member 2230 fixed in the housing 2100, the displacement limiting member 2230 has therein an accommodating space 2231 extending along the X-axis, and a side wall of the accommodating space 2231 is provided with a side wall thread 2232. The driving member 2220 is arranged in the accommodating space 2231. The driving member 2220 is preferably a circular cylinder having a driving member thread 2222 on a side surface that matches the side wall thread 2232. In the embodiment shown in FIG. 2F, when the lock body 2300 is closed, an end of the engagement member 2310 extends through the hole 2214 of the force application member 2210 and the hole 2224 of the driving member 2220 and is engaged with the groove portion 2104, to limit the rotation of the driving device 2200. In the embodiment shown in FIG. 2G, when the lock body 2300 is opened (for example, using a key), the engagement member 2310 exits from the hole 2214 of the force application member 2210 and the hole 2224 of the driving member 2220 to release the engagement with the groove portion 2104, thereby releasing the limitation of the rotation of the driving device 2200.

Next, in the embodiment shown in FIG. 2H, when the force application member 2210 is rotated in a direction parallel to a YZ plane as a result of an external force exerted by the user on the force bearing portion 2211, the driving member 2220 rotated associatively. Under an action between the side wall thread 2232 and the driving member thread 2222, an end 2221 of the driving member 2220 facing the rear end portion 2420 is moved along the X-axis direction. The end 2221 abuts against the rear end portion 2420. Therefore, the movement of the driving member 2220 in the X-axis direction changes an extent to which the rear end portions 2420 are opened relative to the X-axis, thereby changing the extent to which the front end portions 2410 are opened relative to the X-axis. Next, in the embodiments shown in FIG. 2I, if the lock body 2300 is closed (for example, using a key) in this case, an end of the engagement member 2310 is then engaged with the groove portion 2104 to limit the rotation of the driving device 2200. As a result, the front end portion 1410 has a desired opening extent, for example, slightly wider than a width of a lock hole of an electronic device, and is engaged with and fixed to the lock hole.

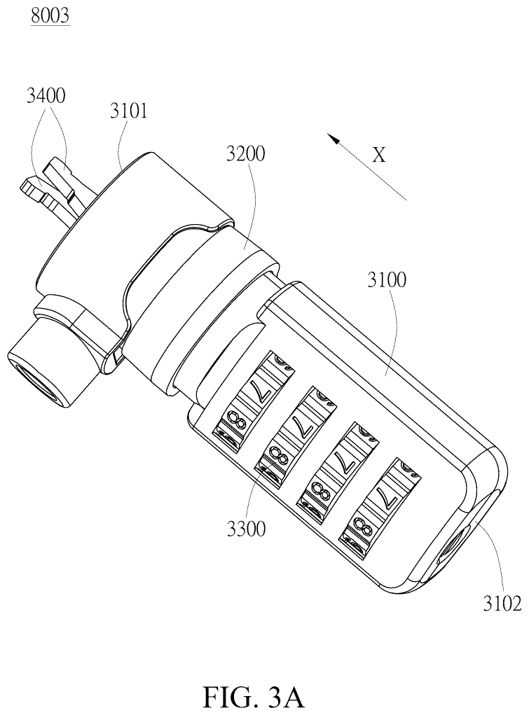

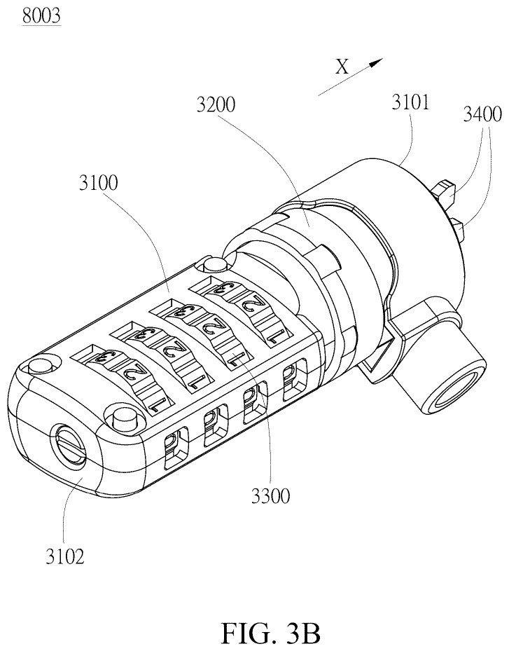

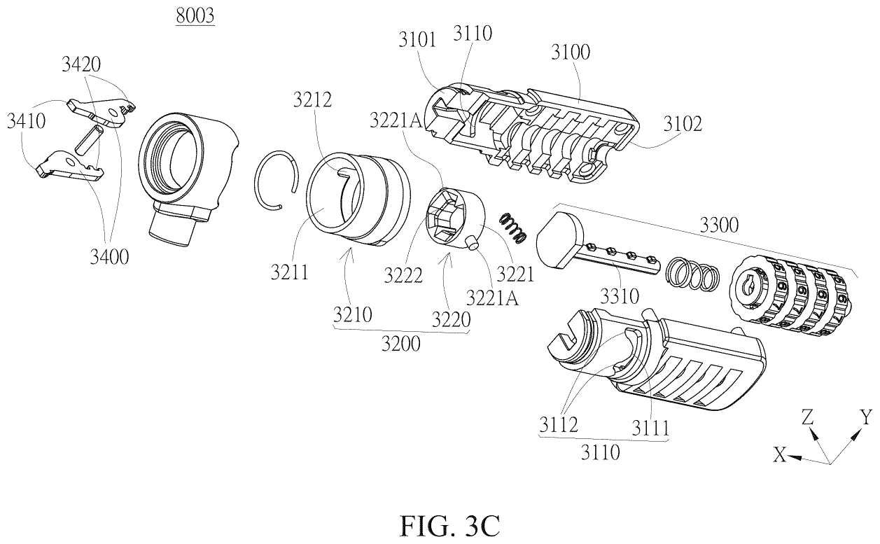

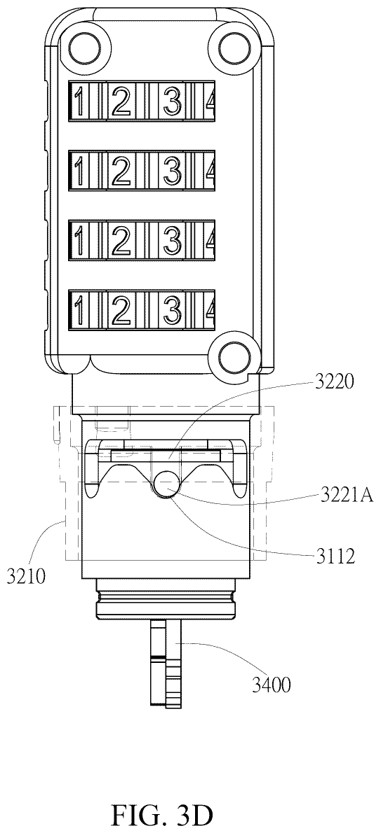

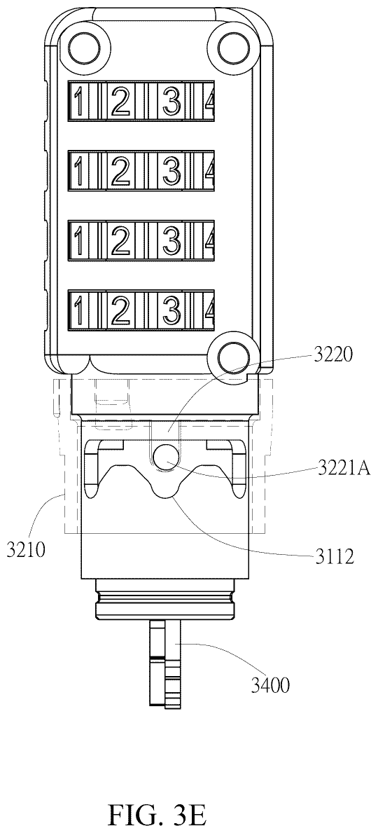

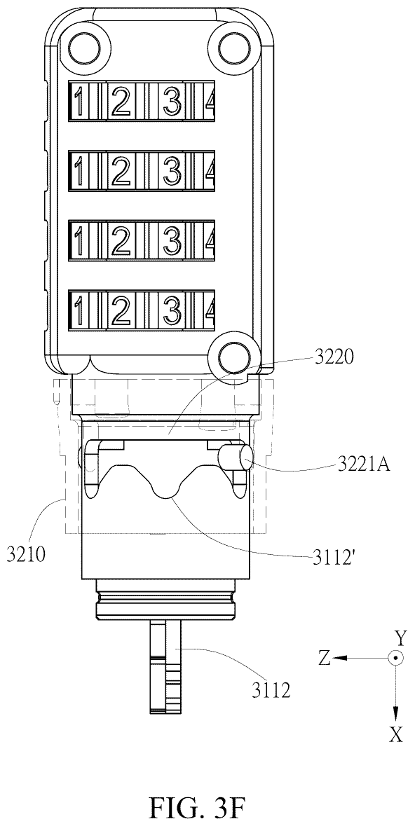

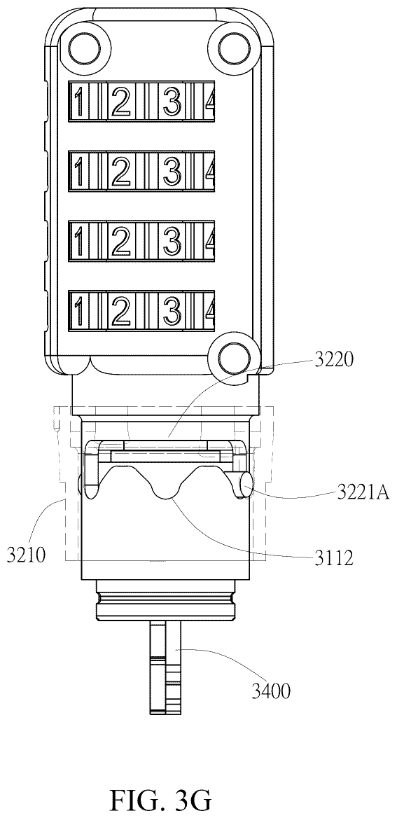

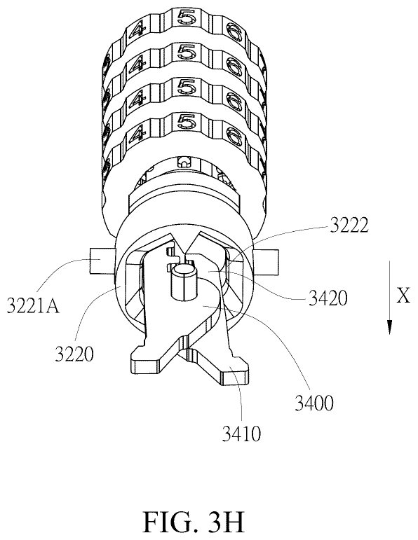

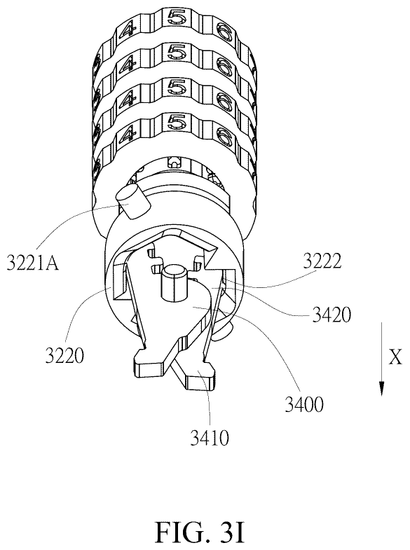

In another embodiment shown in FIG. 3A to FIG. 3C, a lockset 8003 of the utility model includes a housing 3100, a hook 3400, a driving device 3200, and a lock body 3300. The housing 3100 extends along an X-axis, and includes a front end 3101 and a rear end 3102 opposite to each other. The hook 3400 is arranged in the housing 3100, and can be rotated relative to the housing 3100. The hook 3400 is preferably arranged in pairs, each including a front end portion 3410 partially extending out of the front end 3101. A portion of the driving device 3200 is arranged in the housing 3100, and a portion thereof extends out of the housing 3100 between the rear end 3102 and the front end 3101. The driving device 3200 can be rotated relative to the X-axis to change an extent to which the front end portions 3410 are opened relative to the X-axis. The lock body 3300 is arranged on a side of the driving device 3200. When the lock body 3300 is closed, the lock body 3300 limits the rotation of the driving device 3200.

Further, in the embodiment shown in FIG. 3C, the hook 3400 includes a rear end portion 3420 extending in a direction opposite to the front end portion 3410. The driving device 3200 includes a force application member 3210 and a driving member 3220. The force application member 3210 is arranged around the housing 3100 between the rear end 3102 and the front end 3101. The force application member 3210 has a force application member inner wall 3211, and the force application member inner wall 3211 has a force application member engagement portion 3212. The driving member 3220 is arranged in the housing 3100. The driving member 3220 has a driving member surface 3221 and a driving member inner wall 3222. The driving member surface 3221 has a driving member fixture block 3221A. The driving member fixture block 3221A may extend through the housing 3100 to enter the force application member engagement portion 3212, to cause the driving member 3220 and the force application member 3210 to rotate associatively. A distance between the driving member inner wall 3222 and the X-axis varies along a circumferential direction. The rear end portion 3420 is arranged in the driving member 3220 and abuts against the driving member inner wall 3222. The lock body 3300 includes an engagement member 3310 that can be moved along an X-axis direction. When the lock body 3300 is closed, an end of the engagement member 3310 abuts against an end of the driving member 3220 away from the hook 3400 to limit the movement of the driving member 3220 along the X-axis.

More specifically, in the embodiment shown in FIG. 3C, the housing 3100 has a hollowed-out portion 3110, and the hollowed-out portion 3110 includes a movement groove 3111 extending relative to the X-axis along a circumferential direction and a plurality of limiting grooves 3112 extending from the movement groove to the hook 3400 along the X-axis direction. When the lock body 3300 is opened, the driving member 3220 can be moved, so that the driving member fixture block 3221A can be moved in the movement groove 3111 and the plurality of limiting grooves 3112, and when the lock body 3300 is closed, the driving member fixture block 3221A is located in one of the plurality of limiting grooves 3112.

Actions of the lockset 8003 are described below by using embodiments shown in FIG. 3D to FIG. 3I. In the embodiment shown in FIG. 3D, when the lock body 3300 is closed (for example, a character wheel of the lock body 3300 is rotated to a locked position), the movement of the driving member 3220 along the X-axis is limited. In this way, the driving member fixture block 3221A is limited from moving away from the limiting groove 3112, and the force application member 3210 engaged with the driving member 3220 cannot be rotated. In the embodiment shown in FIG. 3E, when the lock body 3300 is opened (for example, a character wheel of the lock body 3300 is rotated to an unlocked position), the movement of the driving member 3220 along the X-axis is released. In this way, the driving member fixture block 3221A can be moved away from the limiting groove 3112, and the force application member 3210 engaged with the driving member 3220 can be rotated.

Next, in the embodiment shown in FIG. 3F, when the force application member 3210 rotates in a direction parallel to a YZ plane as a result of an external force exerted by a user, the driving member 3220 is rotated, so that the driving member fixture block 3221A is moved to a position opposite to an other limiting groove 3112′. The X-axis, the Y-axis, and the Z-axis are orthogonal. Then, in the embodiment shown in FIG. 3G, the driving member fixture block 3221A is moved into the limiting groove 3112′ by an elastic force of an elastic device such as a spring. According to another aspect, in embodiments shown in FIG. 3H to FIG. 3I, a distance between the driving member inner wall 3222 relative and the X-axis varies along a circumferential direction, and the rear end portion 3420 is arranged in the driving member 3220 and abuts against the driving member inner wall 3222. Therefore, when the driving member 3220 is rotated, the hook 3400 can be rotated to change an extent to which the front end portions 3410 are opened relative to the X-axis to meet a requirement, for example, slightly wider than a width of a lock hole of an electronic device, and is engaged with and fixed to the lock hole.

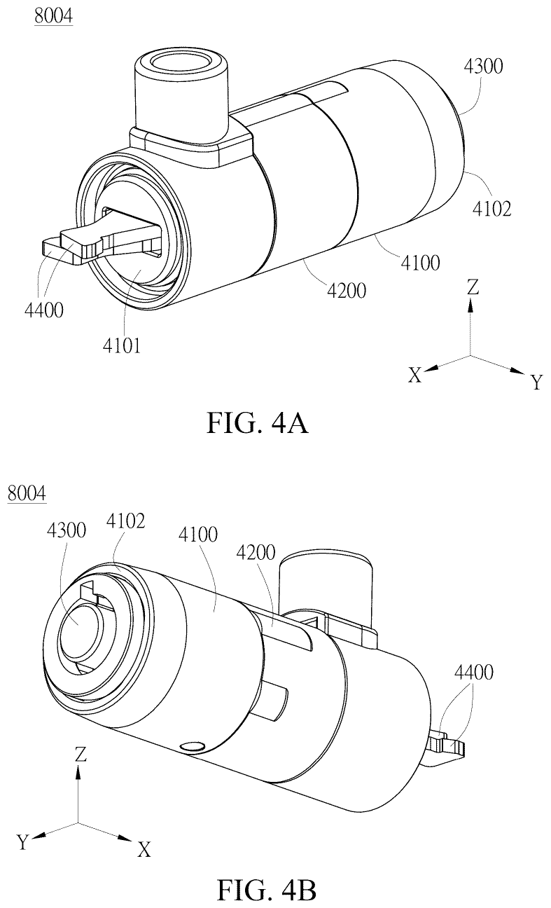

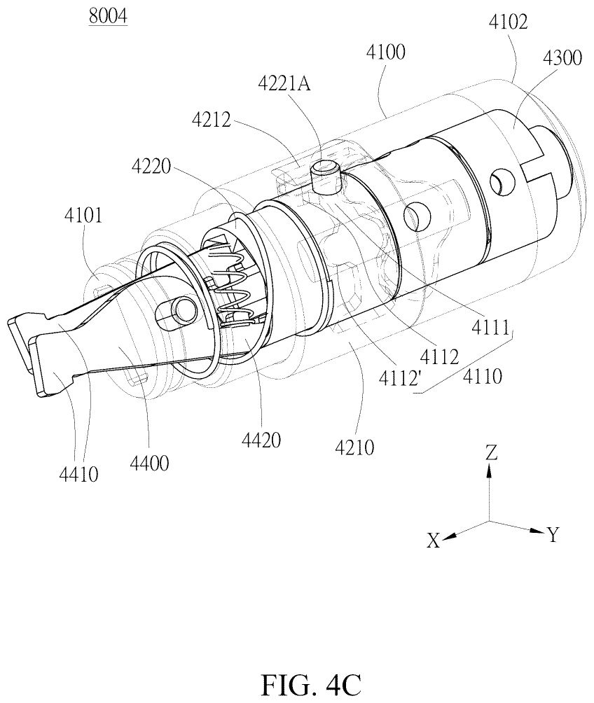

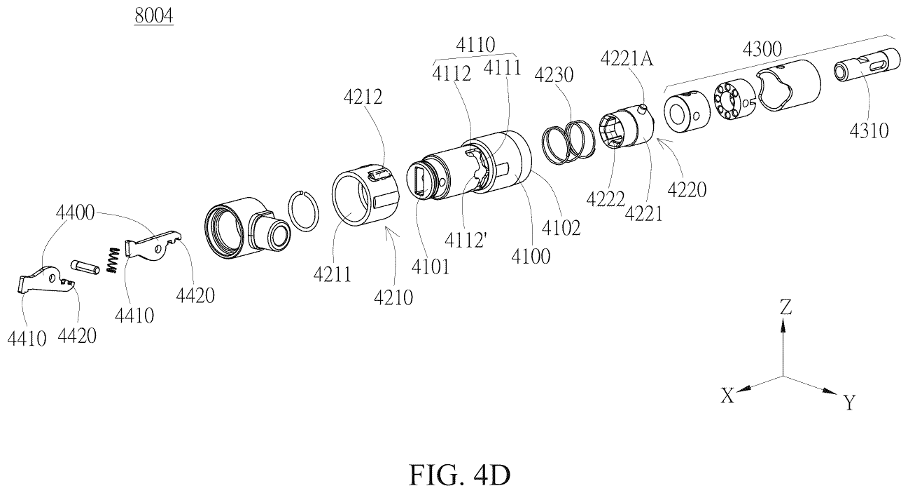

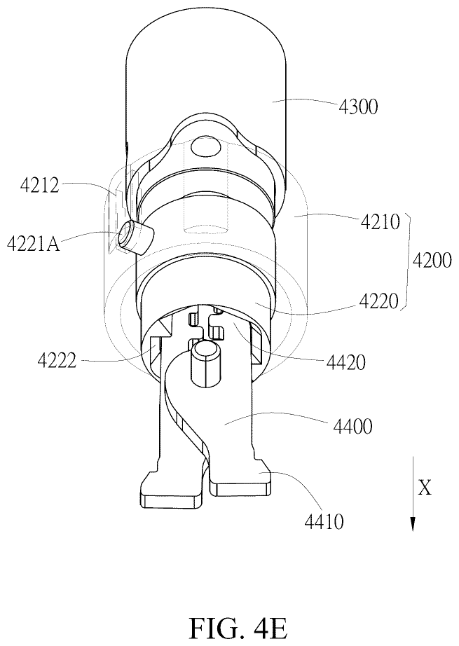

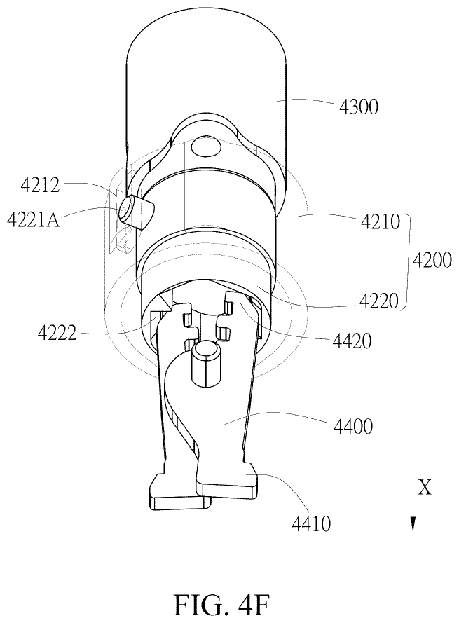

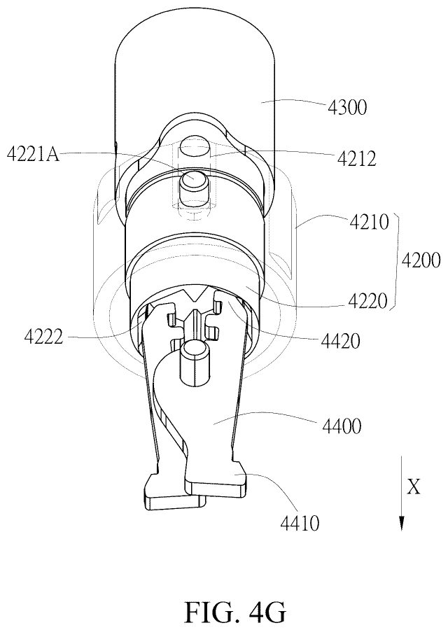

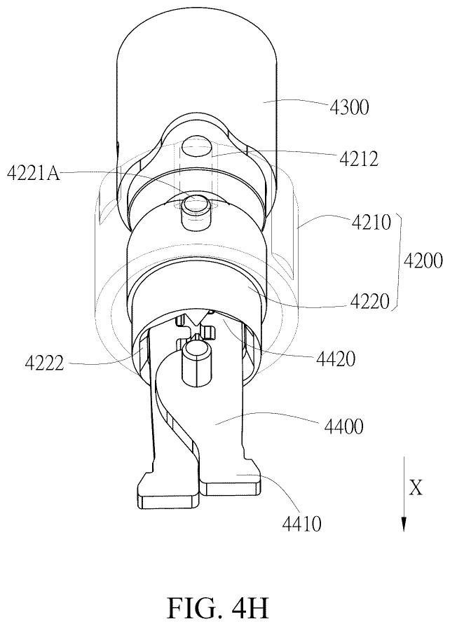

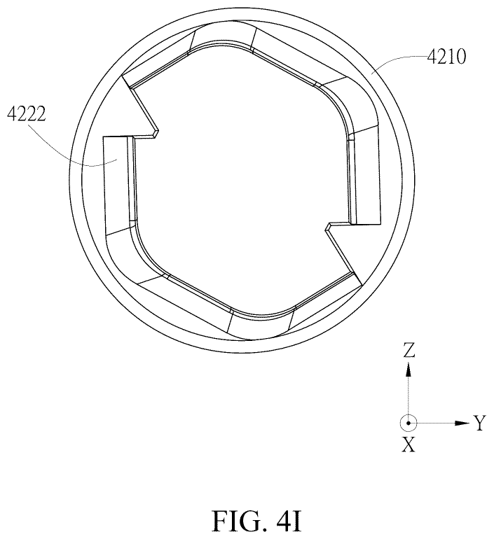

In another embodiment shown in FIG. 4A to FIG. 4D, a lockset 8004 of the utility model includes a housing 4100, a hook 4400, a driving device 4200, and a lock body 4300. The housing 4100 extends along an X-axis, and includes a front end 4101 and a rear end 4102 opposite to each other. The hook 4400 is arranged in the housing 4100, and can be rotated relative to the housing 4100. The hook 4400 is preferably arranged in pairs, each including a front end portion 4410 partially extending out of the front end 4101. A portion of the driving device 4200 is arranged in the housing 4100, and a portion thereof extends out of the housing 4100 between the rear end 4102 and the front end 4101. The driving device 4200 can be rotated relative to the X-axis to change an extent to which the front end portions 4410 are opened relative to the X-axis. The lock body 4300 is arranged on a side of the driving device 4200. When the lock body 4300 is closed, the lock body 4300 limits rotation of the driving device 4200.

Further, in the embodiments shown in FIG. 4C and FIG. 4D, the hook 4400 includes a rear end portion 4420 extending in a direction opposite to the front end portion 4410. The driving device 4200 includes a force application member 4210 and a driving member 4220. The force application member 4210 is arranged around the housing 4100 between the rear end 4102 and the front end 4101, where the force application member 4210 has a force application member inner wall 4211, and the force application member inner wall 4211 has a force application member engagement portion 4212. The driving member 4220 is arranged in the housing 4100, where the driving member 4220 has a driving member surface 4221 and a driving member inner wall 4222, the driving member surface 4221 has a driving member fixture block 4221A, the driving member fixture block 4221A extends through the housing 4100 to enter force application member engagement portion 4212, to cause the driving member 4220 and the force application member 4210 to rotate associatively. A distance between the driving member inner wall 4222 and the X-axis varies along a circumferential direction, and the rear end portion 4420 is arranged in the driving member 4220 and abuts against the driving member inner wall 4222. The lock body 4300 includes an engagement member 4310 that can be moved along an X-axis direction. When the lock body 4300 is closed, an end of the engagement member 4310 abuts against an end of the driving member 4220 away from the hook 4400 to limit the movement of the driving member 4220 along the X-axis.

More specifically, in the embodiments shown in FIG. 4C and FIG. 4D, the housing 4100 has a hollowed-out portion 4110, and the hollowed-out portion 4110 includes a movement groove 4111 extending relative to the X-axis along a circumferential direction and a plurality of limiting grooves 4112 extending from the movement groove to the hook 4400 along the X-axis direction. When the lock body 4300 is opened, the driving member 4220 can be moved, so that the driving member fixture block 4221A can be moved in the movement groove 4111 and the plurality of limiting grooves 4112. When the lock body 4300 is closed, the driving member fixture block 4221A is located in one of the plurality of limiting grooves 4112.

Actions of the lockset 8004 are described below by using embodiments shown in FIG. 4E to FIG. 4I. In the embodiment shown in FIG. 4E, when the lock body 4300 is closed (for example, locked through a key), the movement of the driving member 4220 along the X-axis is limited. In this way, the driving member fixture block 4221A is limited from moving away from the limiting groove 4112 (see FIG. 4C), and the force application member 4210 engaged with the driving member 4220 cannot be rotated. In the embodiment shown in FIG. 4F, when the lock body 4300 is opened (for example, unlocked through a key), the movement of the driving member 4220 along the X-axis is released. The driving member 4220 may be moved along the X-axis by the elastic force of the elastic member 4230 (see FIG. 4D) to move away from the hook 4400. In this way, the driving member fixture block 4221A can be moved away from the limiting groove 4112, and the force application member 4210 engaged with the driving member 4220 can be rotated.

Next, in the embodiment shown in FIG. 4G, when the force application member 4210 rotates relative to the X-axis as a result of an external force exerted by a user, the driving member 4220 is rotated, so that the driving member fixture block 4221A is moved to a position opposite to an other limiting groove 4112′ (see FIG. 4C). The X-axis, the Y-axis, and the Z-axis are orthogonal. Then, in the embodiment shown in FIG. 4H, the user can overcome the elasticity of an elastic member 4230 by applying force to the engagement member 4310 (see FIG. 4D), and push the driving member 4210 to move along the X-axis, so that the driving member fixture block 4221A moves into the limiting groove 4112′. The rear end portion 4420 is arranged in the driving member 4220 and abuts against the driving member inner wall 4222, and the driving member inner wall 4222 varies in the circumferential direction relative to the distance of the X-axis as shown in FIG. 4I. Therefore, when the driving member 4220 is rotated, the hook 4400 can be rotated to change an extent to which the front end portions 4410 are opened relative to the X-axis to meet a requirement, for example, slightly wider than a width of a lock hole of an electronic device, and is engaged with and fixed to the lock hole.

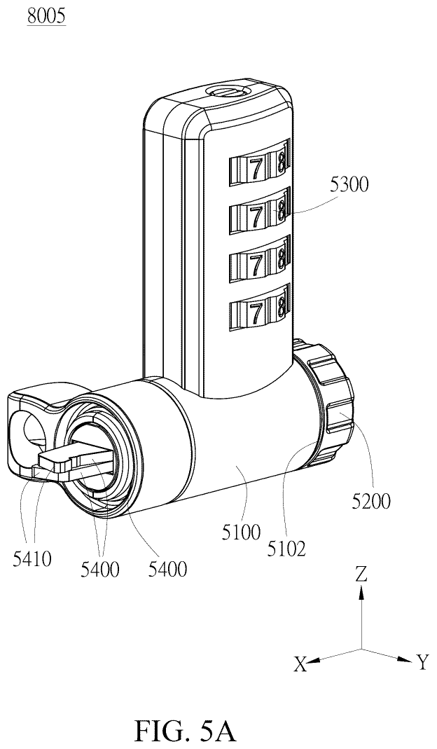

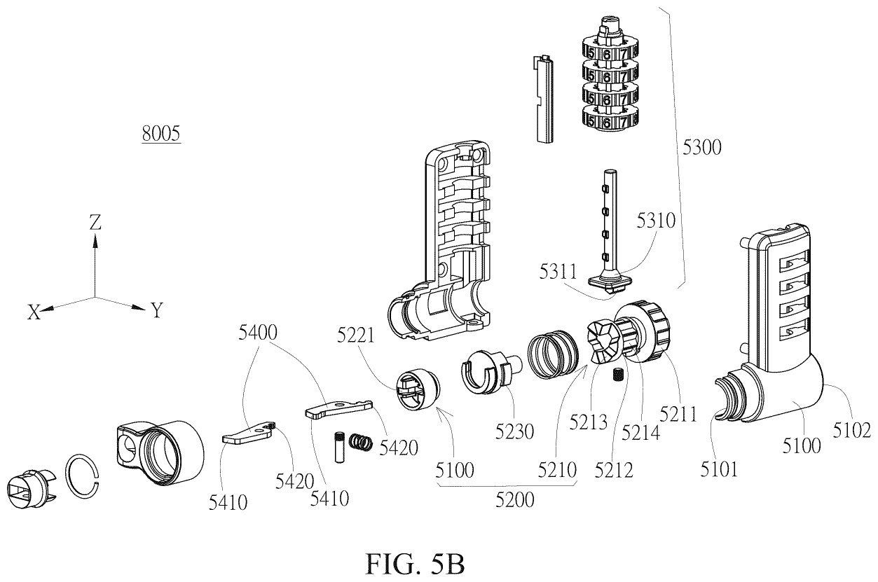

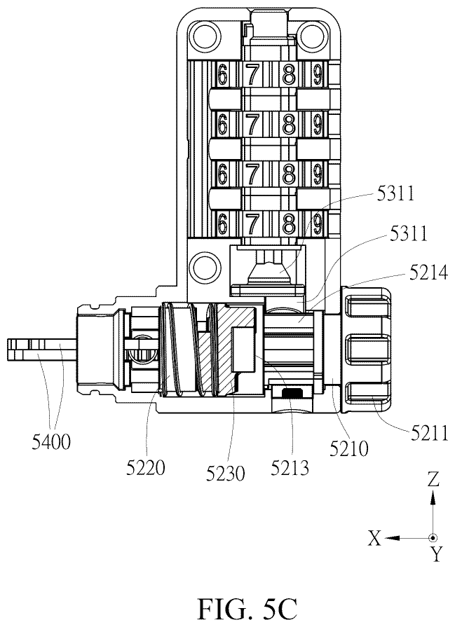

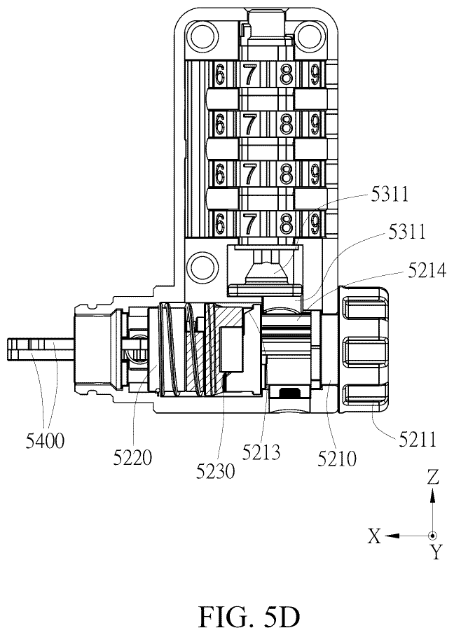

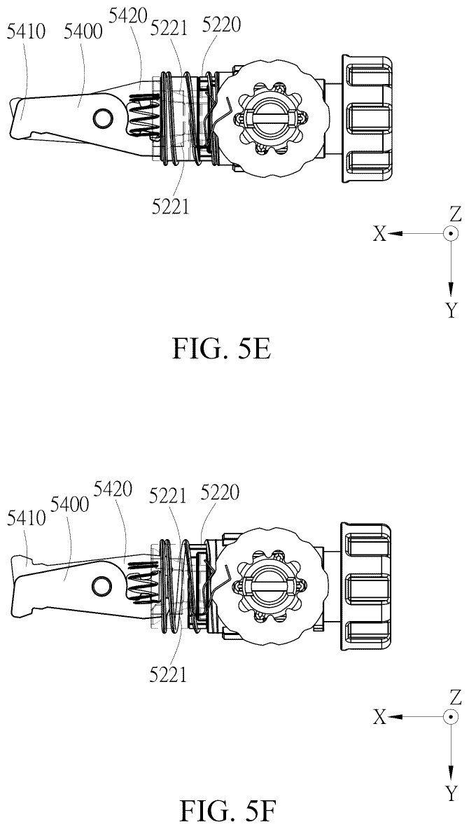

In another embodiment shown in FIG. 5A and FIG. 5B, a lockset 8005 of the utility model includes a housing 5100, a hook 5400, a driving device 5200, and a lock body 5300. The housing 5100 extends along an X-axis, and includes a front end 5101 and a rear end 5102 opposite to each other. The hook 5400 is arranged in the housing 5100, and can be rotated relative to the housing 5100. The hook 5400 is preferably arranged in pairs, each including a front end portion 5410 partially extending out of the front end 5101. A portion of the driving device 5200 is arranged in the housing 5100, and a portion thereof extends out of the housing 5100 from the rear end 5102. The driving device 5200 can be rotated relative to the X-axis to change an extent to which the front end portions 5410 are opened relative to the X-axis. The lock body 5300 is arranged on a side of the driving device 5200. When the lock body 5300 is closed, the lock body 5300 limits rotation of the driving device 5200.

Further, in the embodiment shown in FIG. 5B, the hook 5400 includes a rear end portion 5420 extending in a direction opposite to the front end portion 5410. The driving device 5200 includes a force application member 5210 and a driving member 5220. The force application member 5210 includes a force bearing portion 5211 extending out of the housing 5100 from the rear end 5102 and a force application portion 5212 arranged inside the housing 5100, where the force bearing portion 5211 and the force application portion 5212 are connected and can be rotated associatively relative to the housing 5100. The force application member 5210 has a segment gap surface 5213 on a side facing the hook 5400. The driving member 5220 is arranged in the housing 5100 and has a driving member inner wall 5221, where a distance between the driving member inner wall 5221 and the X-axis gradually increases as approaching the hook 5400, the driving member inner wall 5221 abuts against the rear end portion 5420. An other side of the driving member 5220 relative to the hook 5400 abuts against the segment gap surface 5213 through an intermediate member 5230, and the force application member 5210 is rotated to cause the driving member 5220 to move along the X-axis direction to change an extent to which the front end portions 5410 are opened relative to the X-axis. The lock body 5300 includes an engagement member 5310 that can be moved along an X-axis direction. When the lock body 5300 is closed, an end of the engagement member 5310 is engaged with a force application member surface 5214 of the force application member 5210 to limit the rotation of the driving device 5200. In this embodiment, the lock body 5300 is a combination lock, and the engagement member 5310 includes a lock shaft rod.

More specifically, in embodiments shown in FIG. 5C and FIG. 5D, the force application member 5210 can be rotated relative to the X-axis by the force bearing portion 5211, thereby causing the segment gap surface 5213 to rotate. The driving member 5220 moves along the X-axis when the segment gap surface 5213 is rotated because of a relationship that the driving member indirectly abuts against the segment gap surface 5213, so as to approach or away from the hook 5400. When the lock body 5300 is closed (that is, the lockset 8005 is in a locked state), a displacement of the engagement member 5310 is limited. If an end 5311 is engaged with the force application member surface 5214, the rotation of the force application member 5210 is limited. When the lock body 5300 is opened (that is, the lockset 8005 is in an unlocked state), the engagement member 5310 can be moved, so that one end 5311 is not engaged with the force application member surface 5214. The force application member 5210 can be rotated, so that the segment gap surface 5213 is rotated together, to drive the driving member 5220 to move along the X-axis direction. In this way, in embodiments shown in 5E and 5F, the rear end portion 5420 that abuts against the driving member inner wall 5221 can be further moved. As a result, the hook 5400 is rotated to change an extent to which the front end portions 5410 are opened relative to the X-axis.

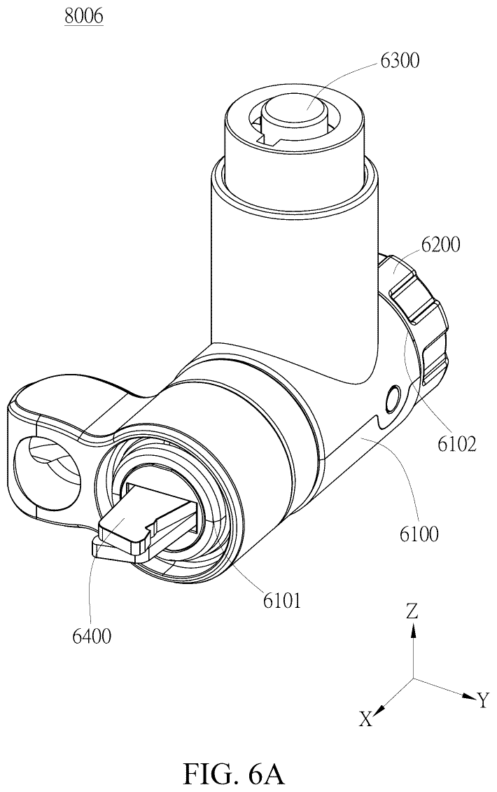

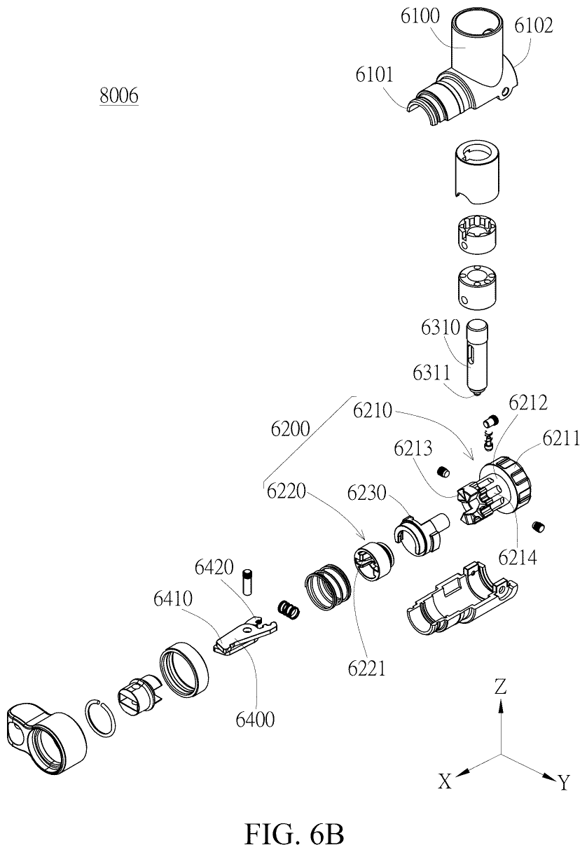

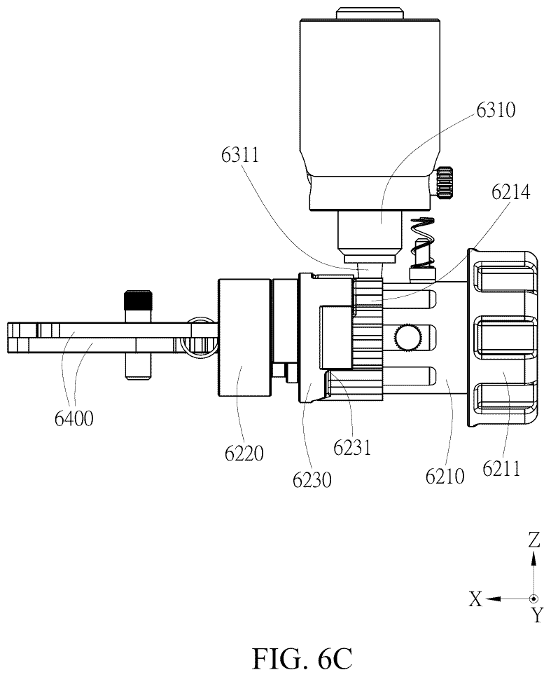

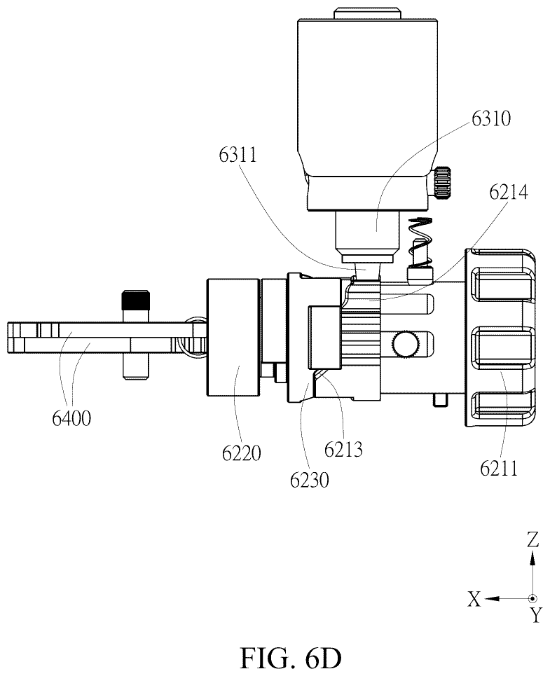

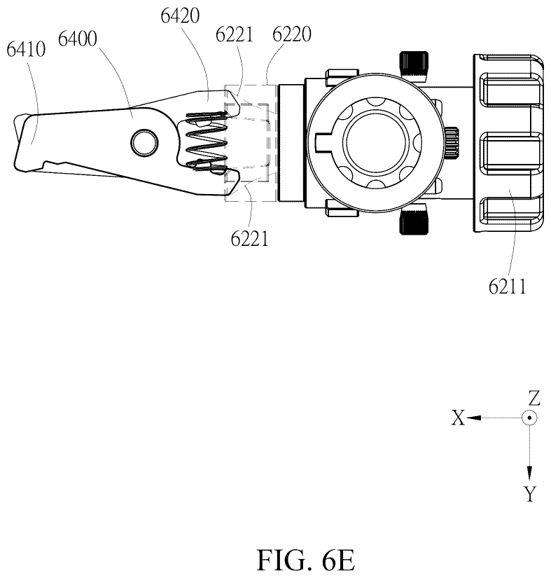

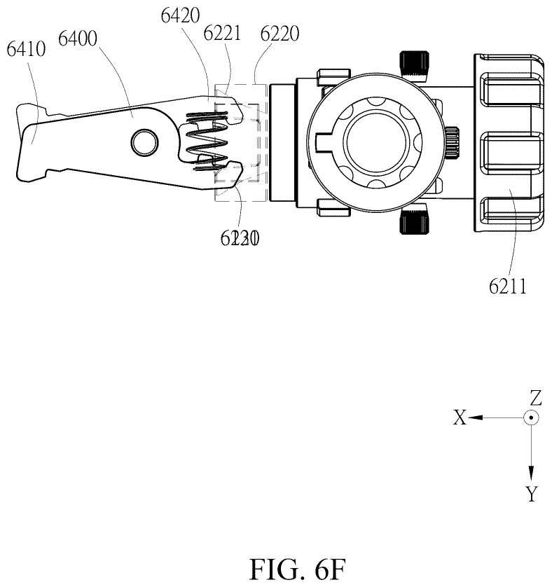

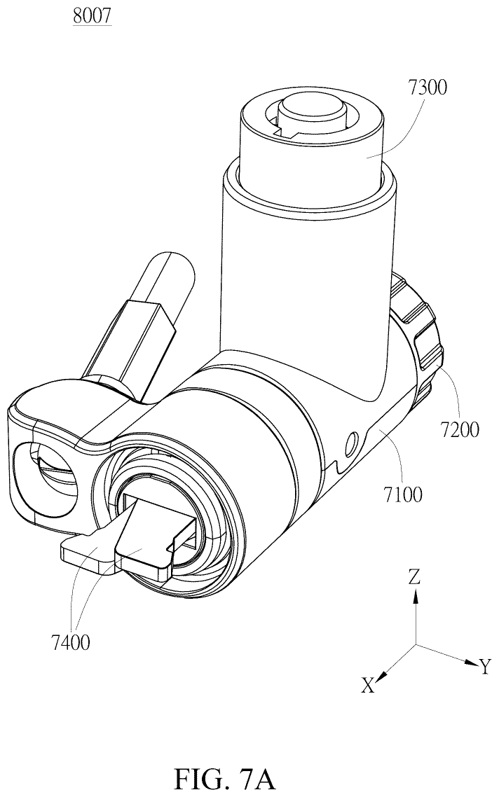

In another embodiment shown in FIG. 6A and FIG. 6B, a lockset 8006 of the utility model includes a housing 6100, a hook 6400, a driving device 6200, and a lock body 6300. The housing 6100 extends along an X-axis, and includes a front end 6101 and a rear end 6102 opposite to each other. The hook 6400 is arranged in the housing 6100, and can be rotated relative to the housing 6100. The hook 6400 is preferably arranged in pairs, each including a front end portion 6410 partially extending out of the front end 6101. A portion of the driving device 6200 is arranged in the housing 6100, and a portion thereof extends out of the housing 6100 from the rear end 6102. The driving device 6200 can be rotated relative to the X-axis to change an extent to which the front end portions 6410 are opened relative to the X-axis. The lock body 6300 is arranged on a side of the driving device 6200. When the lock body 6300 is closed, the lock body 6300 limits the rotation of the driving device 6200.

Further, in the embodiment shown in FIG. 6B, the hook 6400 includes a rear end portion 6420 extending in a direction opposite to the front end portion 6410. The driving device 6200 includes a force application member 6210 and a driving member 6220. The force application member 6210 includes a force bearing portion 6211 extending out of the housing 6100 from the rear end 6102 and a force application portion 6212 arranged inside the housing 6100. The force bearing portion 6211 and the force application portion 6212 are connected and can be rotated associatively relative to the housing 6100. The force application member 6210 has a segment gap surface 6213 on a side facing the hook 6400. The driving member 6220 is arranged in the housing 6100 and has a driving member inner wall 6221. A distance between the driving member inner wall 6221 and the X-axis gradually increases as approaching the hook 6400, and the driving member inner wall 6221 abuts against the rear end portion 6420. An other side of the driving member 6220 relative to the hook 6400 indirectly abuts against the segment gap surface 6213 through an intermediate member 6230. The force application member 6210 is rotated to cause the driving member 6220 to move along the X-axis direction to change an extent to which the front end portions 6410 are opened relative to the X-axis. The lock body 6300 includes an engagement member 6310 that can be moved along a direction perpendicular to the X-axis. When the lock body 6300 is closed, an end of the engagement member 6310 is engaged with a force application member surface 6214 of the force application member 6210 to limit the rotation of the driving device 6200. In this embodiment, the lock body 6300 is a key lock, and the engagement member 6310 includes a protruding post.

More specifically, in embodiments shown in FIG. 6C and FIG. 6D, the force application member 6210 can be rotated relative to the X-axis by the force bearing portion 6211, thereby causing the segment gap surface 6213 to rotate. The driving member 6220 moves along the X-axis when the segment gap surface 6213 is rotated because of a relationship that the driving member indirectly abuts against the segment gap surface 6213, so as to approach or away from the hook 6400. When the lock body 6300 is closed (that is, the lockset 8006 is in a locked state), a displacement of the engagement member 6310 is limited. If an end 6311 is engaged with the force application member surface 6214, the rotation of the force application member 6210 is limited. When the lock body 6300 is opened (that is, the lockset 8006 is in an unlocked state), the engagement member 6310 can be moved, so that one end 6311 is not engaged with the force application member surface 6214. The force application member 6210 can be rotated, so that the segment gap surface 6213 is rotated together, to drive the driving member 6220 to move along the X-axis direction. In this way, in embodiments shown in FIG. 6E and FIG. 6F, the rear end portion 6420 that abuts against the driving member inner wall 6221 can be further moved. As a result, the hook 6400 is rotated to change an extent to which the front end portions 6410 are opened relative to the X-axis.

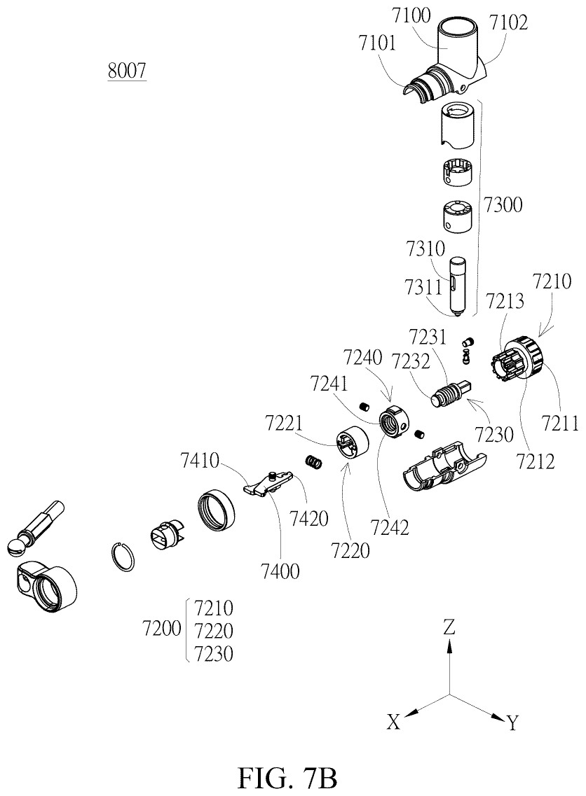

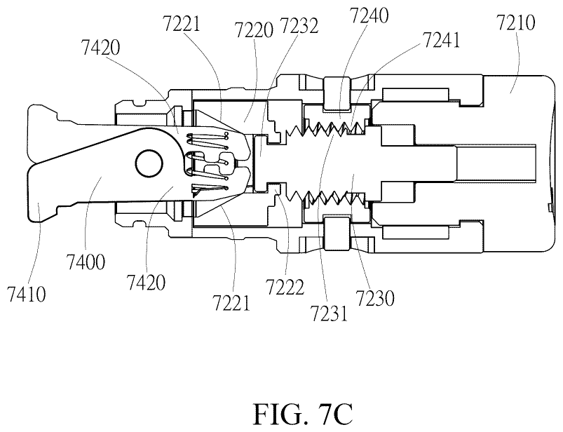

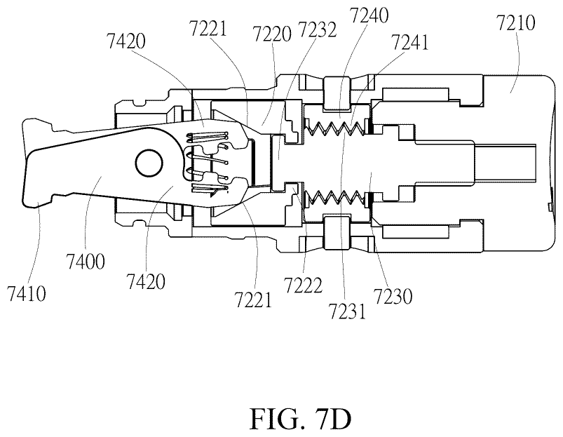

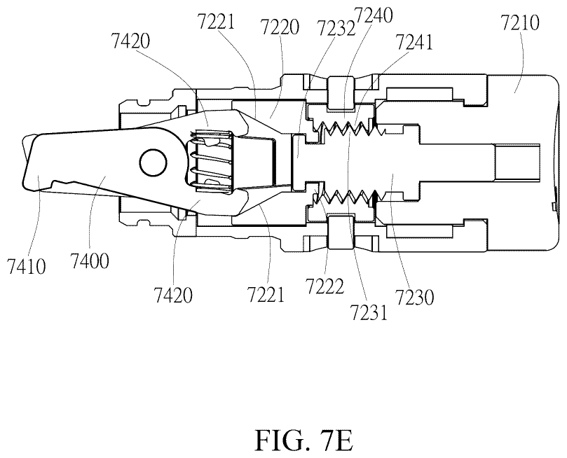

In another embodiment shown in FIG. 7A and FIG. 7B, a lockset 8007 of the utility model includes a housing 7100, a hook 7400, a driving device 7200, and a lock body 7300. The housing 7100 extends along an X-axis, and includes a front end 7101 and a rear end 7102 opposite to each other. The hook 7400 is arranged in the housing 7100, and can be rotated relative to the housing 7100. The hook 7400 is preferably arranged in pairs, each including a front end portion 7410 partially extending out of the front end 7101. A portion of the driving device 7200 is arranged in the housing 7100, and a portion thereof extends out of the housing 7100 from the rear end 7102. The driving device 7200 can be rotated relative to the X-axis to change an extent to which the front end portions 7410 are opened relative to the X-axis. The lock body 7300 is arranged on a side of the driving device 7200. When the lock body 7300 is closed, the lock body 7300 limits the rotation of the driving device 7200.

Further, in the embodiment shown in FIG. 7B, the hook 7400 includes a rear end portion 7420 extending in a direction opposite to the front end portion 7410. The driving device 7200 includes a force application member 7210, a transmission member 7230, and a driving member 7220. The force application member 7210 includes a force bearing portion 7211 extending out of the housing 7100 from the rear end 7102 and a force application portion 7212 arranged inside the housing 7100, where the force bearing portion 7211 and the force application portion 7212 are connected and can be rotated associatively relative to the housing 7100. The transmission member 7230 is arranged in the housing 7100, can be rotated associatively with the force application member 7210, and can be moved along an X-axis direction. The driving member 7220 is arranged in the housing 7100 and has a driving member inner wall 7221. A distance between the driving member inner wall 7221 and the X-axis gradually increases as approaching the hook 7400, and the driving member inner wall 7221 abuts against the rear end portion 7420. An other side of the driving member 7220 relative to the hook 7400 abuts against the transmission member 7230, and the force application member 7210 is rotated to cause the transmission member 7230 to move along the X-axis direction, and drives the driving member 7220 to move along the X-axis direction to change an extent to which the front end portions 6410 are opened. The lock body 7300 includes an engagement member 7310 that can be moved along a direction perpendicular to the X-axis. When the lock body 7300 is closed, an end 7311 of the engagement member 7310 is engaged with a force application member surface 7213 of the force application member 7210 to limit the rotation of the driving device 7200.

More specifically, the driving device 7200 further includes a displacement limiting member 7240 fixed in the housing 7100, the displacement limiting member 7240 has therein an accommodating space 7241 extending along the X-axis, and a side wall of the accommodating space 7241 is provided with a side wall thread 7242. The transmission member 7230 is arranged in the accommodating space 7241. The transmission member 7230 is a circular cylinder having a transmission member thread 7231 on a side surface that matches the side wall thread 7242. An end of the force application member 7210 can be inserted into the force application member 7210 and interfere in a rotation direction relative to the X-axis through a shape thereof. In this way, when the force application member 7210 is rotated, the transmission member 7230 is rotated associatively, and under an action between the side wall thread 7242 and the transmission member thread 7231, the transmission member 7230 moves along the X-axis direction. According to another aspect, in embodiments shown in FIG. 7C to FIG. 7E, an end of the transmission member 7230 close to the hook 7400 has a flange 7232 engaged with an interference portion 7222 of the driving member 7220. In this way, when the transmission member 7230 moves in the X-axis direction, the driving member 7220 can be driven to move in the X-axis direction, thereby changing an extent to which the front end portions 7410 are opened.

Although the foregoing description and drawings have disclosed preferred embodiments of the utility model, it should be understood that various additions, many modifications, and substitutions may be used in the preferred embodiments of the utility model without departing from the spirit and scope of the principles of the utility model as defined by the appended patent application. A person of ordinary skill in the technical field of the utility model may understand that the utility model can be used in modifications of many forms, structures, arrangements, proportions, materials, elements, and assemblies. Therefore, the embodiments disclosed herein should be regarded as illustrative of the utility model, rather than as limiting the utility model. The scope of the utility model shall be defined by the scope of the appended patent application, and shall cover the legal equivalents thereof, and shall not be limited to the foregoing description.

What is claimed is:

1. A lockset, comprising:
a housing, extending along an X-axis, and comprising a front end and a rear end opposite to each other;
a hook, arranged in the housing and rotatable relative to the housing, wherein the hook comprises a front end portion that partially extends out of the front end;
a driving device, wherein a portion of the driving device is arranged in the housing, and a portion thereof extends out of the housing from the rear end or between the rear end and the front end, and the driving device is ratable relative to the X-axis to change an extent to which the front end portions are opened relative to the X-axis; and
a lock body, arranged on a side of the driving device, wherein when the lock body is closed, the lock body limits rotation of the driving device.

2. The lockset according to claim 1, wherein
the hook comprises a rear end portion extending in a direction opposite to the front end portion;
the driving device comprises:
a force application member, comprising a force bearing portion extending out of the housing from the rear end and a force application portion arranged inside the housing, wherein the force bearing portion and the force application portion are connected and rotatable associatively relative to the housing;
a driving member, arranged in the housing and rotatable associatively with the force application member, wherein the driving member has a driving member inner wall, a distance between the driving member inner wall and the X-axis varies along a circumferential direction, and the rear end portion is arranged in the driving member and abuts against the driving member inner wall; and
the lock body comprises an engagement member that is movable along a direction perpendicular to the X-axis, and when the lock body is closed, an end of the engagement member is engaged with a driving member surface of the driving member to limit the rotation of the driving device.

3. The lockset according to claim 1, wherein
the hook comprises a rear end portion extending in a direction opposite to the front end portion;
the driving device comprises:
a force application member, comprising a force bearing portion extending out of the housing from the rear end and a force application portion arranged inside the housing, wherein the force bearing portion and the force application portion are connected and rotatable associatively relative to the housing;
a driving member, arranged in the housing and rotatable associatively with the force application member to move along an X-axis direction on a side of the rear end portion facing the X-axis, and abutting against the rear end portion to change the extent to which the front end portions are opened; and
the lock body comprises an engagement member, the engagement member is movable along a direction perpendicular to the X-axis, and extends through the force application member and the driving member to reach a housing inner wall of the housing, and when the lock body is closed, an end of the engagement member is engaged with the housing inner wall to limit the rotation of the driving device.

4. The lockset according to claim 3, wherein
the driving device further comprises a displacement limiting member fixed in the housing, the displacement limiting member has therein an accommodating space extending along the X-axis, and a side wall of the accommodating space is provided with a side wall thread;
the driving member is arranged in the accommodating space, and the driving member is a cylinder having a driving member thread on a side surface that matches the side wall thread; and
when the force application member is rotated, the driving member is rotated associatively, and under an action between the side wall thread and the driving member thread, an end of the driving member facing the rear end portion is moved along the X-axis direction.

5. The lockset according to claim 2, wherein the lock body is a key lock, and the engagement member comprises a protruding post.

6. The lockset according to claim 2, wherein the lock body is a combination lock, and the engagement member comprises a lock shaft rod.

7. The lockset according to claim 1, wherein
the hook comprises a rear end portion extending in a direction opposite to the front end portion;
the driving device comprises:
a force application member, arranged around the housing between the rear end and the front end, wherein the force application member has a force application member inner wall, and the force application member inner wall has a force application member engagement portion; and
a driving member, arranged in the housing, wherein the driving member has a driving member surface and a driving member inner wall, the driving member surface has a driving member fixture block, the driving member fixture block extends through the housing to enter force application member engagement portion, to cause the driving member and the force application member to rotate associatively, a distance between the driving member inner wall and the X-axis varies along a circumferential direction, and the rear end portion is arranged in the driving member and abuts against the driving member inner wall; and
the lock body comprises an engagement member movable along the X-axis direction, and when the lock body is closed, an end of the engagement member abuts against an end of the driving member away from the hook to limit movement of the driving member along the X-axis.

8. The lockset according to claim 7, wherein the housing has a hollowed-out portion, the hollowed-out portion comprises a movement groove extending relative to the X-axis along a circumferential direction and a plurality of limiting grooves extending from the movement groove the hook along the X-axis direction, when the lock body is opened, the driving member fixture block is movable in the movement groove and the plurality of limiting grooves, and when the lock body is closed, the driving member fixture block is located in one of the plurality of limiting grooves.

9. The lockset according to claim 7, wherein the lock body is a key lock, and the engagement member comprises a protruding post.

10. The lockset according to claim 7, wherein the lock body is a combination lock, and the engagement member comprises a lock shaft rod.

11. The lockset according to claim 1, wherein
the hook comprises a rear end portion extending in a direction opposite to the front end portion;
the driving device comprises:
a force application member, comprising a force bearing portion extending out of the housing from the rear end and a force application portion arranged inside the housing, wherein the force bearing portion and the force application portion are connected and rotatable associatively relative to the housing, and the force application member has a segment gap surface on a side facing the hook; and
a driving member, arranged in the housing and having a driving member inner wall, wherein a distance between the driving member inner wall and the X-axis gradually increases as approaching the hook, the driving member inner wall abuts against the rear end portion, an other side of the driving member relative to the hook abuts against the segment gap surface, and the force application member is rotated to cause the driving member to move along the X-axis direction to change the extent to which the front end portions are opened; and
the lock body comprises an engagement member movable along a direction perpendicular to the X-axis, and when the lock body is closed, an end of the engagement member is engaged with a force application member surface of the force application member to limit the rotation of the driving device.

12. The lockset according to claim 11, wherein the lock body is a key lock, and the engagement member comprises a protruding post.

13. The lockset according to claim 11, wherein the lock body is a combination lock, and the engagement member comprises a lock shaft rod.

14. The lockset according to claim 1, wherein
the hook comprises a rear end portion extending in a direction opposite to the front end portion;
the driving device comprises:
a force application member, comprising a force bearing portion extending out of the housing from the rear end and a force application portion arranged inside the housing, wherein the force bearing portion and the force application portion are connected and rotatable associatively relative to the housing;
a transmission member, arranged in the housing, rotatable associatively with the force application member, and movable along an X-axis direction; and
a driving member, arranged in the housing and having a driving member inner wall, wherein a distance between the driving member inner wall and the X-axis gradually increases as approaching the hook, the driving member inner wall abuts against the rear end portion, an other side of the driving member relative to the hook abuts against the transmission member, and the force application member is rotated to cause the transmission member to move along the X-axis direction, and drives the driving member to move along the X-axis direction to change the extent to which the front end portions are opened; and
the lock body comprises an engagement member movable along a direction perpendicular to the X-axis, and when the lock body is closed, an end of the engagement member is engaged with a force application member surface of the force application member to limit the rotation of the driving device.

15. The lockset according to claim 14, wherein
the driving device further comprises a displacement limiting member fixed in the housing, the displacement limiting member has therein an accommodating space extending along the X-axis, and a side wall of the accommodating space is provided with a side wall thread;
the transmission member is arranged in the accommodating space, and the transmission member is a circular cylinder having a transmission member thread on a side surface that matches the side wall thread; and
when the force application member is rotated, the transmission member is rotated associatively, and under an action between the side wall thread and the transmission member thread, the transmission member moves along the X-axis direction.

16. The lockset according to claim 14, wherein the lock body is a key lock, and the engagement member comprises a protruding post.

17. The lockset according to claim 14, wherein the lock body is a combination lock, and the engagement member comprises a lock shaft rod.
